(19) United States
(12) Patent Application Publication
(10) Pub. No.: US 2026/0148195 A1
(43) Pub. Date: May 28, 2026

(54) TIME/DATE ADJUSTMENT APPARATUS, TIME/DATE ADJUSTMENT METHOD, AND STORAGE MEDIUM STORING PROGRAM

(71) Applicant: E4 Inc., Tokyo (JP)

(72) Inventor: Taichiro SUGIMOTO, Tokyo (JP)

(21) Appl. No.: 19/104,206

(22) PCT Filed: Jun. 26, 2023
(86) PCT No.: PCT/JP2023/023536

§ 371 Date: Feb. 14, 2025

(30) Foreign Application Priority Data
Aug. 16, 2022 (JP) 2022-129689

(51) Int. Cl. G06Q 10/1093

(52) U.S. Cl. CPC G06Q 10/1093

(57) ABSTRACT

In a time/date adjustment apparatus, a time/date adjustment unit divides participant candidates into teams, based on an assignment calculation expression, extracts common available time/dates satisfying an adjustment condition of all of the participant candidates constituting the team as first candidate time/dates for each of the teams, determines time/dates being the first candidate time/dates of at least one of the teams as second candidate time/dates, in response to selection of an adjustment partner, determines an assembly time/date out of the second candidate time/dates, and assigns a plan of the assembly time/date to one of the teams in which the assembly time/date is extracted as the first candidate time/dates according to an assignment order.

### TECHNICAL FIELD

The present invention relates to a time/date adjustment apparatus, a time/date adjustment method, and a program. The present invention claims priority based on Japanese Patent Application No. 2022-129689 filed on Aug. 16, 2022, the contents of which are incorporated herein by reference for designated states where incorporation of literature by reference is permitted.

### BACKGROUND ART

Conventionally, adjustment of a time/date (time and date) of an assembly in business requires a large number of steps such as checking of a schedule of each participant and securing a site, and is therefore considerably bothersome work taking time and efforts.

Note that, regarding checking of schedules of participants, it is considered that a calendar tool is referred to, as many businesspersons manage their plans using a calendar tool provided on the Internet in recent years.

Regarding the calendar tool, for example, PTL 1 provides the following description: “a schedule information sharing method including the steps of: performing membership application registration by each of a plurality of applicants and a plurality of users, the plurality of applicants applying for distribution of schedule information, the plurality of users using the schedule information of the distribution, the plurality of applicants and the plurality of users each being a member of a system that distributes and shares the schedule information via the Internet; executing by a scheduler performing schedule management below; disclosing and distributing, by the applicant, the schedule information to the user; registering, by the user, a target desiring distribution of the disclosed schedule information; and based on a registered desired distribution target of the user, synchronizing and presetting the schedule information related thereto to a calendar of all of user terminals.”

### CITATION LIST

### Patent Literature

PTL 1: JP 2019-219831 A

### SUMMARY OF INVENTION

### Technical Problem

In a technique described in PTL 1, a plurality of users being members of a system can share schedule information with each other, and use the schedule information for adjustment of a time/date of an assembly. However, even if the system is used, schedules of participants in an assembly may be updated and changed from moment to moment, which makes it difficult to perform adjustment of a time/date of the assembly without causing an overlap between existing plans of each of the participants and time at which the assembly is held, in other words, without causing a double booking.

For example, in a case of a company in which many assemblies, such as business discussions and recruitment interviews, are carried out every day, it is often the case that participations in the assemblies such as the business discussions are distributed and assigned to respective people in charge for a plurality of staff members in charge and teams in charge, in consideration of a task load and a schedule of each person in charge (a staff member in charge or a team in charge). Thus, it is desirable that a task of assignment of participation in an assembly to each person in charge and a time/date adjustment task be able to be simultaneously implemented. However, in a conventional time/date adjustment tool, time/date adjustment cannot be performed without a double booking simultaneously with assignment of participation in an assembly in consideration of team division and a task load (states of other assembly plans) of each person in charge.

The present invention is made in view of such circumstances as described above, and has an object to perform time/date adjustment without a double booking simultaneously with assigning participation in an assembly to participant candidates (employees or the like on an organizer side in charge of a business discussion, a recruitment interview, or the like) in the assembly on the organizer side, in consideration of team division of the participant candidates and states of existing plans.

### Solution to Problem

The present application includes a plurality of solutions to at least a part of the problems described above, examples of which are described as follows.

In order to solve the problems described above, a time/date adjustment apparatus according to one aspect of the present invention includes an adjustment condition setting unit configured to set an adjustment condition template that can be repeatedly used for time/date adjustment of different assemblies, and a time/date adjustment unit configured to perform adjustment of an assembly time/date, based on the adjustment condition template.

The adjustment condition setting unit registers participant candidates in the assembly and an adjustment condition including an assignment method including an assignment calculation expression and an assignment order in the adjustment condition template, based on input from an adjustment initiator. The time/date adjustment unit, in response to an adjustment partner performing access based on access information corresponding to the adjustment condition template, segments the participant candidates into teams, based on the assignment calculation expression, refers to schedule information of the participant candidates managed by a calendar tool, extracts common available time/dates satisfying the adjustment condition of all of the participant candidates constituting the team as first candidate time/dates for each of the teams, determines time/dates being the first candidate time/dates of at least one of the teams as second candidate time/dates, presents the second candidate time/dates to a terminal apparatus used by the adjustment partner, in response to selection of the adjustment partner, determines the assembly time/date out of the presented second candidate time/dates, and assigns a plan of the assembly time/date to one of the teams in which the determined assembly time/date is extracted as the first candidate time/dates according to the assignment order.

Based on input from the adjustment initiator, the adjustment condition setting unit can register the adjustment condition including a determination unit span and an assignment upper limit number in the adjustment condition template. The time/date adjustment unit can exclude all of the time/dates in the determination unit span in which the number of determination target plans of the participant candidate in the determination unit span is equal to or more than the assignment upper limit number from the first candidate time/dates of the team to which the participant candidate in which the number of determination target plans in the determination unit span is equal to or more than the assignment upper limit number belongs.

Based on input from the adjustment initiator, the adjustment condition setting unit can register the adjustment condition including a determination unit span in the adjustment condition template. The time/date adjustment unit can count the number of determination target plans of each of the participant candidates in the determination unit span including the determined assembly time/date, regard a maximum value of the number of determination target plans of each of the participant candidates belonging to the team as the number of determination target plans of the team to which the participant candidates belong, and assign the plan of the assembly time/date to the team having a smallest number of determination target plans in the determination unit span including the determined assembly time/date out of the teams in which the determined assembly time/date is extracted as the first candidate time/dates.

The adjustment condition setting unit can consider the plan of the assembly time/date determined using the same adjustment condition template as the determination target plan.

The adjustment condition setting unit, in response to input by the adjustment initiator, can register the adjustment condition including designation of a determination keyword in the adjustment condition template, and consider an existing plan in which information related to the existing plan includes the determination keyword out of the existing plans of the participant candidate in the schedule information as the determination target plan.

The adjustment condition setting unit can cause the adjustment initiator to select a day unit, a week unit, or a month unit as the determination unit span.

The adjustment condition setting unit can cause the adjustment initiator to select one of the assignment upper limit number being equal for the teams, the assignment upper limit number for each of the teams, the assignment upper limit number being equal for the participant candidates, or the assignment upper limit number for each of the participant candidates, as the assignment upper limit number.

Based on the assignment calculation expression, the time/date adjustment unit can segment the participant candidates into the teams, each team including one or two or more of the participant candidates.

The time/date adjustment unit can register the plan of the assembly time/date in the schedule information of the participant candidates constituting the team assigned the plan of the assembly time/date.

The time/date adjustment unit can notify the participant candidates constituting the team assigned the plan of the assembly time/date of the plan of the assembly time/date.

A time/date adjustment method according to another aspect of the present invention includes an adjustment condition setting step of setting an adjustment condition template that can be repeatedly used for time/date adjustment of different assemblies, and a time/date adjustment step of performing adjustment of an assembly time/date, based on the adjustment condition template.

The adjustment condition setting step includes registering participant candidates in the assembly and an adjustment condition including an assignment method including an assignment calculation expression and an assignment order in the adjustment condition template, based on input from an adjustment initiator. The time/date adjustment step includes, in response to an adjustment partner performing access based on access information corresponding to the adjustment condition template, segmenting the participant candidates into teams, based on the assignment calculation expression, referring to schedule information of the participant candidates managed by a calendar tool, extracting common available time/dates satisfying the adjustment condition of all of the participant candidates constituting the team as first candidate time/dates for each of the teams, determining time/dates being the first candidate time/dates of at least one of the teams as second candidate time/dates, presenting the second candidate time/dates to a terminal apparatus used by the adjustment partner, in response to selection of the adjustment partner, determining the assembly time/date out of the presented second candidate time/dates, and assigning a plan of the assembly time/date to one of the teams in which the determined assembly time/date is extracted as the first candidate time/dates according to the assignment order.

A program according to yet another aspect of the present invention causes a computer to function as an adjustment condition setting unit configured to set an adjustment condition template that can be repeatedly used for time/date adjustment of different assemblies, and a time/date adjustment unit configured to perform adjustment of an assembly time/date, based on the adjustment condition template. The adjustment condition setting unit registers participant candidates in the assembly and an adjustment condition including an assignment method including an assignment calculation expression and an assignment order in the adjustment condition template, based on input from an adjustment initiator.

The time/date adjustment unit, in response to an adjustment partner performing access based on access information corresponding to the adjustment condition template, segments the participant candidates into teams, based on the assignment calculation expression, refers to schedule information of the participant candidates managed by a calendar tool, extracts common available time/dates satisfying the adjustment condition of all of the participant candidates constituting the team as first candidate time/dates for each of the teams, determines time/dates being the first candidate time/dates of at least one of the teams as second candidate time/dates, presents the second candidate time/dates to a terminal apparatus used by the adjustment partner, in response to selection of the adjustment partner, determines the assembly time/date out of the presented second candidate time/dates, and assigns a plan of the assembly time/date to one of the teams in which the determined assembly time/date is extracted as the first candidate time/dates according to the assignment order.

### Advantageous Effects of Invention

According to the present invention, time/date adjustment can be performed without a double booking simultaneously with assigning participation in an assembly to participant candidates of the assembly on the organizer side, in consideration of team division of the participant candidates and states of existing plans in a schedule.

Problems, configurations, and effects other than those described above will become apparent in the following description of embodiments.

### BRIEF DESCRIPTION OF DRAWINGS

FIG. 1 is a diagram illustrating a configuration example of a time/date adjustment system according to one embodiment of the present invention.

FIG. 2 is a diagram illustrating an example of each of member information, user information, adjustment condition template information, and time/date adjustment information.

FIG. 3 is a sequence diagram for illustrating an example of processing at the time of member registration and use registration.

FIG. 4 is a sequence diagram for illustrating an example of adjustment condition template creation processing.

FIG. 5 is a diagram illustrating a display example of an adjustment condition template list screen.

FIG. 6 is a diagram illustrating a display example of a template management information input screen.

FIG. 7 is a diagram illustrating a display example of a date and time information input screen.

FIG. 8 is a diagram illustrating a first display example of a participant information input screen.

FIG. 9 is a diagram illustrating a second display example of the participant information input screen.

FIG. 10 is a diagram illustrating a third display example of the participant information input screen.

FIG. 11 is a diagram illustrating a fourth display example of the participant information input screen.

FIG. 12 is a diagram illustrating a fifth display example of the participant information input screen.

FIG. 13 is a diagram illustrating a display example of an assignment calculation expression editing screen.

FIG. 14 is a sequence diagram for illustrating an example (use template) of time/date adjustment processing.

FIG. 15 is a diagram illustrating a display example of the adjustment condition template list screen.

FIG. 16 is a diagram illustrating a display example of a comment confirmation screen.

FIG. 17 is a diagram for illustrating an example of team division using an assignment calculation expression and a method of determining second candidate time/dates.

FIG. 18 is a diagram for illustrating an example of team division using the assignment calculation expression and the method of determining the second candidate time/dates.

FIG. 19 is a diagram illustrating a display example of a time/date selection screen.

FIG. 20 is a diagram illustrating a display example of a time/date confirmation screen.

FIG. 21 is a diagram illustrating a display example of a booker information input screen.

FIG. 22 is a diagram for illustrating an example of an assignment method.

FIG. 23 is a diagram for illustrating an example of the assignment method.

FIG. 24 is a diagram for illustrating an example of the assignment method.

FIG. 25 is a diagram for illustrating an example of the assignment method.

FIG. 26 is a diagram illustrating a display example of a time/date notification screen.

### DESCRIPTION OF EMBODIMENTS

One embodiment according to the present invention will be described below with reference to the drawings. Note that, in all the drawings for describing one embodiment, the same members are denoted by the same reference signs in principle, and repeated description thereof will be omitted. In the following embodiment, constituent elements (including element steps and the like) thereof are not necessarily essential, except for a case in which there is particular and explicit description, a case in which it is considered that those are obviously essential in principle, and the like. Concerning descriptions “to consist of A”, “to be composed of A”, “to have A”, and “to include A”, except for a case in which there is particular and explicit description that only the element is provided, and the like, elements other than the element are not to be excluded. Similarly, in the following embodiment, when there is a reference to a shape, a positional relationship, and the like of a constituent element and the like, a shape and the like that are substantially close to or similar to those shape and the like are included, except for a case in which there is particular and explicit description, a case in which it is considered that those are not obviously true in principle, and the like.

### Time/Date Adjustment System 10 According to One Embodiment of Present Invention

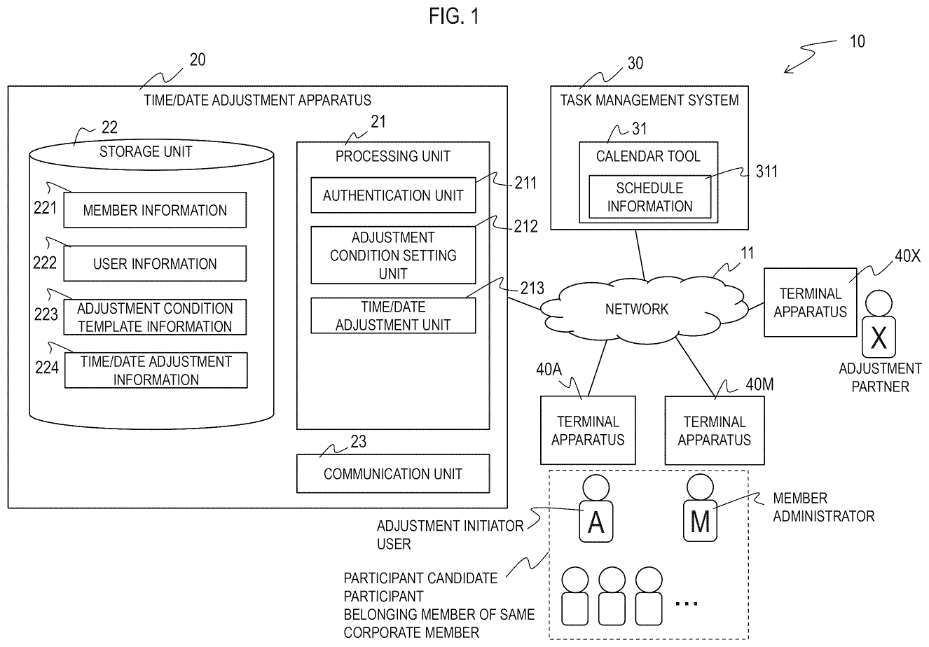

FIG. 1 illustrates a configuration example of a time/date adjustment system 10 according to one embodiment of the present invention.

The time/date adjustment system 10 is for assisting adjustment of a time/date of an assembly. The time/date adjustment system 10 includes a time/date adjustment apparatus 20, a task management system 30, and terminal apparatuses 40A, 40M, and 40X, which are connected via a network 11.

The network 11 is a two-way communication network, as typified by the Internet, a mobile phone communication network, and the like.

The time/date adjustment apparatus 20 assists time/date adjustment with an adjustment partner to participate in an assembly, and performs assignment of participation in the assembly to participant candidates in the assembly on an organizer side. Note that, in FIG. 1, only an adjustment partner X is illustrated as the adjustment partner; however, there are a plurality of adjustment partners. As the participants in the assembly on the organizer side, an adjustment initiator A and belonging members (including a member administrator M (details will be described later) ) of an organization (a company or the like; a corporate member to be described later) to which the adjustment initiator A belongs are assumed. Note that, in this specification, among persons to actually participate in the assembly, the “participant” in the assembly is defined as a participant on the organizer side, and unless otherwise explicitly noted, the adjustment partner x to participate in the assembly is not included in the “participant” (is not referred to as the “participant”).

The task management system 30 includes a calendar tool 31 as a web application, is a system for to enhance efficiency of tasks or the like due to information sharing, plan management, or the like, and refers to a system that is widely provided for general consumers, self-employed people, corporations, and the like with or without a charge. As the calendar tool 31, for example, Google Calendar (trademark) and Microsoft Outlook (trademark) can be employed. The calendar tool 31 stores schedule information 311, in which action plans of a user of the calendar tool 31 and a booking status of assembly sites available to the user are registered. In other words, the task management system 30 manages schedule information 311, in which action plans of a user of the calendar tool 31 and a booking status of assembly sites available to the user are registered.

Note that, in a case of the present embodiment, the task management system 30 described as an external system independent of the time/date adjustment apparatus 20, but the task management system 30 may be present in the same apparatus as the time/date adjustment apparatus 20. The calendar tool 31 may be included in the time/date adjustment apparatus 20. In other words, the calendar tool 31 managing the schedule information 311 may be present in a certain system, and the time/date adjustment apparatus 20 may refer to the schedule information 311 from the calendar tool 31.

The terminal apparatus 40A used by the adjustment initiator A includes a general computer, such as a personal computer and a smartphone, that can connect to the time/date adjustment apparatus 20 via the network 11. Similarly, the terminal apparatus 40M used by the member administrator M and the terminal apparatus 40X used by the adjustment partner X each include a general computer.

Note that, in the present embodiment, the adjustment partner X to participate in an assembly operates the terminal apparatus 40X; however, in actuality, a representative (a secretary or the like) of the adjustment partner X may operate the terminal apparatus 40X.

The adjustment initiator A is a belonging member (an employee or the like) of a company or the like that has conducted member registration and use registration (registration of information necessary for making a time/date adjustment function in the time/date adjustment apparatus 20 available) with the time/date adjustment apparatus 20. The company or the like that has conducted member registration with the time/date adjustment apparatus 20 is hereinafter referred to as a corporate member. Among belonging members belonging to the corporate member (company or the like), a belonging member having a user account and having conducted use registration with the time/date adjustment apparatus 20 is defined as a user. It is essential that the adjustment initiator A be a user. Thus, the adjustment initiator A may be hereinafter referred to as a user A. Note that an individual, not a company or the like, can also conduct member registration and use registration with the time/date adjustment apparatus 20. In that case, the individual who has conducted member registration is referred to as an individual member. The individual member and the user can be regarded as the same.

The member administrator M is a belonging member of the same organization being the corporate member as the adjustment initiator A, and manages a member account as a corporate member.

The adjustment initiator A and the member administrator M may be different persons, or may be the same person.

The belonging members belonging to the same corporate member as the member administrator M and the adjustment initiator A, other than the adjustment initiator A, may be users, but this is not essential.

Belonging members belonging to the corporate member of the time/date adjustment apparatus 20 manage their plans, using the calendar tool 31 provided by the task management system 30. The corporate member of the time/date adjustment apparatus 20 manages the booking status of a meeting room, a reception room, a spare room, and the like available to the belonging members as an assembly site, using the calendar tool 31 provided by the task management system 30.

Thus, in the present case, the calendar tool 31 stores the schedule information 311 in which each of plans of the adjustment initiator A and the like who may be participants of an assembly on the organizer side and the booking status of assembly sites available to the adjustment initiator A and the like is registered.

Note that the adjustment partner X may be a user of the time/date adjustment apparatus 20, but this is not essential. The adjustment partner X may use the calendar tool 31, but this is not essential. The adjustment partner X may use a calendar tool provided by a vendor different from a vendor of the calendar tool 31 used by the adjustment initiator A.

The time/date adjustment apparatus 20 includes functional blocks of a processing unit 21, a storage unit 22, and a communication unit 23. The time/date adjustment apparatus 20 includes a general computer such as a server computer including a processor such as a central processing unit (CPU), a memory such as a dynamic random access memory (DRAM), a storage such as a hard disk drive (HDD) and a solid state drive (SSD), an input device such as a keyboard, a mouse, and a touch panel, an output device such as a display, and a communication module such as a network interface card (NIC) (all of which are not illustrated).

The processing unit 21 is implemented by the processor of the computer. The processing unit 21 includes functional blocks of an authentication unit 211, an adjustment condition setting unit 212, and a time/date adjustment unit 213. These functional blocks are implemented by the processor of the computer executing a predetermined program loaded in the memory. Note that a part or all of these functional blocks may be implemented as hardware by an integrated circuit or the like.

For example, the authentication unit 211 receives member registration performed by the member administrator M using the terminal apparatus 40M, and creates member information 221. When the member administrator M logs in as the member administrator after generating the member information 221, for example, the authentication unit 211 performs authentication as the member administrator in response to the member administrator M logging in as the member administrator. For example, in response to use registration at the time of a first login of a user performed by the adjustment initiator A using the terminal apparatus 40A, and when a predetermined condition is satisfied, the authentication unit 211 creates user information 222.

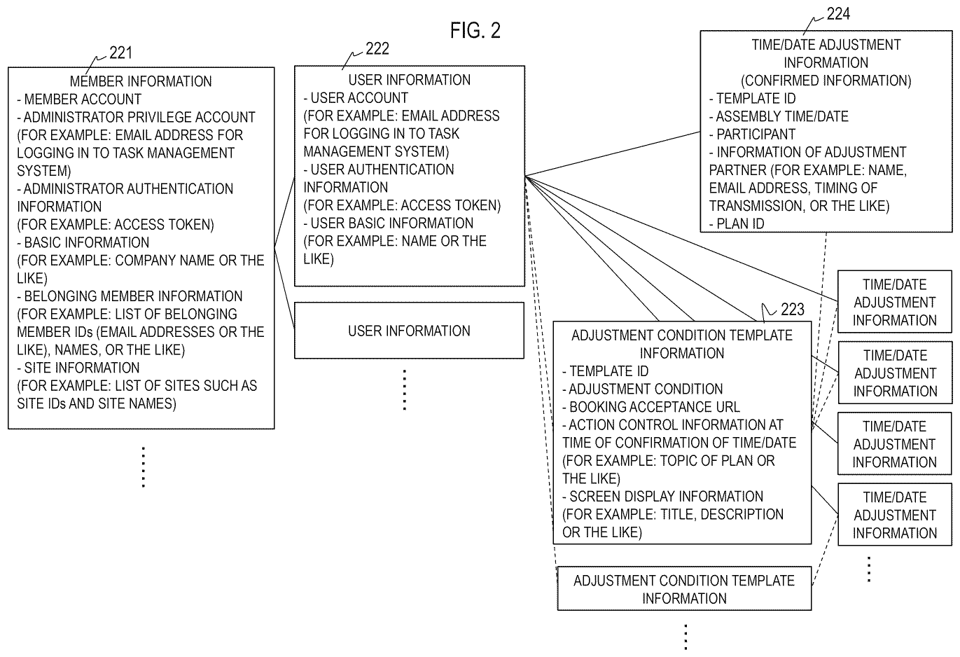

Moreover, the authentication unit 211 accesses the task management system 30 via the network 11, and for example, performs authentication processing in accordance with a protocol such as OAuth, using an administrator privilege account included in the member information 221 and a user account included in the user information 222 corresponding to the adjustment initiator A (user A) (both in FIG. 2) stored in the storage unit 22. Note that the administrator privilege account and the user account may be used in first authentication processing, and in second and following authentication processing, administrator authentication information (an access token or the like) and user authentication information (an access token or the like) (both in FIG. 2) transmitted from the task management system 30 after the first authentication processing has ended can be used.

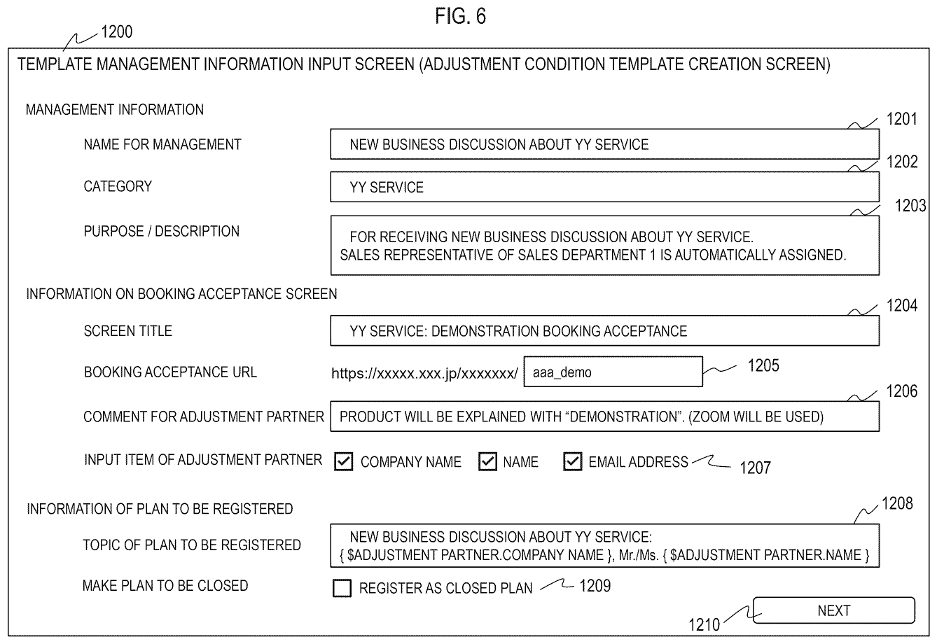

The adjustment condition setting unit 212 causes the terminal apparatus 40A of the adjustment initiator A to display a series of adjustment condition template creation screens (FIG. 6 to FIG. 13) for creating a template for an adjustment condition (hereinafter referred to as an adjustment condition template) including a plurality of items necessary for adjustment of a time/date of an assembly, and creates an adjustment condition template according to an input from the adjustment initiator A on the adjustment condition template creation screens. Then, the adjustment condition setting unit 212 causes the storage unit 22 to store the created adjustment condition template as adjustment condition template information 223 associated with the user information 222 corresponding to the adjustment initiator A. Here, the adjustment condition includes one or more participant candidates on the organizer side, an assignment method, assignment upper limit setting, and the like. The adjustment condition will be described later in detail.

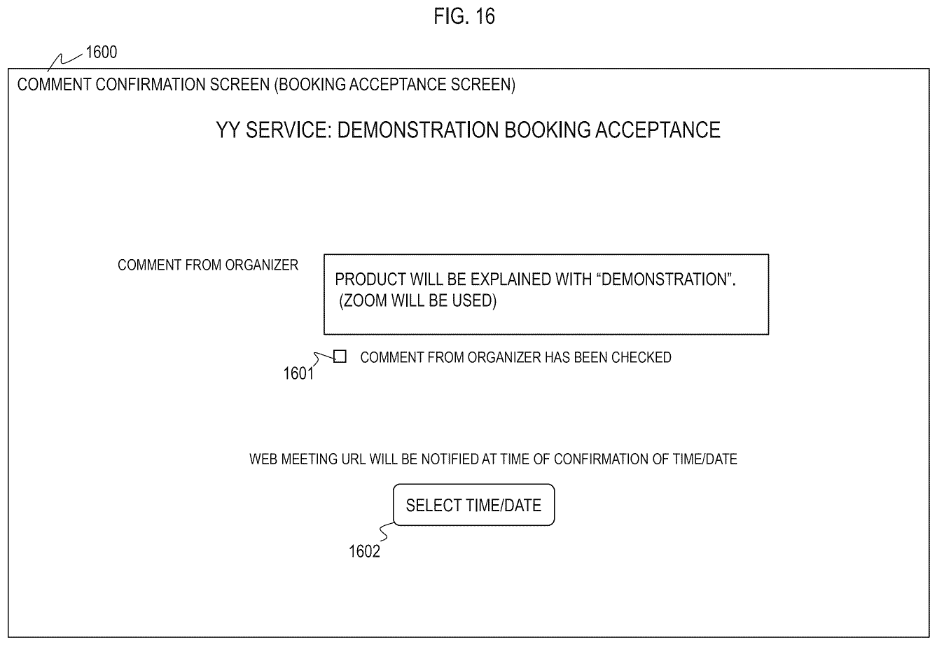

When the adjustment partner X accesses a booking acceptance Uniform Resource Locator (URL) to access a series of booking acceptance screens (FIG. 16 and FIG. 19 to FIG. 21) for performing a participation booking for the assembly set by the adjustment initiator A by using the terminal apparatus 40X, at the time point, the time/date adjustment unit 213 performs the following processing. The booking acceptance URL corresponds to access information of the present invention. Note that the action that the adjustment partner X confirms the assembly time/date via the series of booking acceptance screens is also referred to as “booking” or “participation booking”.

In other words, the time/date adjustment unit 213 performs team division for the participant candidates on the organizer side, according to assignment calculation expression (details will be described later) set by the adjustment initiator A. Here, a team may not only include a plurality of participant candidates, but may also include a single participant candidate. The time/date adjustment unit 213 refers to the schedule information of the participant candidates, and for each team, extracts common available time/dates satisfying the adjustment conditions of all of the participant candidates constituting the team as first candidate time/dates. Then, the time/date adjustment unit 213 considers time/dates being the first candidate time/dates of at least one team as second candidate time/dates. Moreover, the time/date adjustment unit 213 causes the terminal apparatus 40X to display a time/date selection screen as the booking acceptance screen presenting the second candidate time/dates.

Moreover, in response to the adjustment partner X selecting and confirming the assembly time/date out of the second candidate time/dates displayed on the time/date selection screen, based on the participant candidates, the assignment method, and the assignment upper limit setting, the time/date adjustment unit 213 performs assignment of the confirmed assembly time/date to the team of the participant candidates, and confirms all of the participant candidates constituting the assigned team as the participants in the assembly on the organizer side. Moreover, the time/date adjustment unit 213 creates time/date adjustment information 224, causes the storage unit 22 to store the time/date adjustment information 224 in association with the adjustment initiator A, and registers the assembly time/date, the participants on the organizer side, information of the adjustment partner X, and the like.

Note that, even during a short period of time until the adjustment partner X selects one time/date of the second candidate time/dates displayed on the time/date selection screen and confirms the time/date as the assembly time/date, another adjustment partner may make a booking for the time/date selected by the adjustment partner X, for example. Thus, the time/date adjustment unit 213 performs final check that the selected time/date is a common available time/date satisfying the adjustment conditions of all of the participant candidates constituting the team of at least one team, even immediately before the adjustment partner X confirms the assembly time/date.

Then, when the selected time/date is no longer the common available time/date satisfying the adjustment conditions of all of the participant candidates constituting the team in all of the teams, for example, a message such as “The selected time/date has been occupied. Select the time/date again,” may be displayed in the terminal apparatus 40X, and the operation may be returned back to the time/date selection screen. With this configuration, the time/date on which no team can participate can be prevented from being confirmed as the assembly time/date.

Moreover, the time/date adjustment unit 213 registers a plan related to the confirmed assembly time/date in the schedule information 311 of the participants on the on the organizer side (all of the participant candidates constituting the assigned team).

Then, the time/date adjustment unit 213 displays the time/date notification screen in the terminal apparatus 40X used by the adjustment partner X, and thereby notifies the adjustment partner X of a fact that the assembly time/date has been confirmed. The time/date adjustment unit 213 notifies the adjustment partner X, the adjustment initiator A being the organizer, and the like of the fact that the assembly time/date has been confirmed, using an email or the like.

The storage unit 22 is implemented by the memory and the storage of the computer. The storage unit 22 stores the member information 221, the user information 222, adjustment condition template information 223, and the time/date adjustment information 224. Note that the storage unit 22 may store information, data, and the like other than the various pieces of information described above.

The communication unit 23 is implemented by the communication module of the computer. The communication unit 23 connects to the task management system 30, the terminal apparatuses 40A, 40M, and 40X, and the like via the network 11 and communicates various pieces of data and information therewith.

Note that a part or all of the above-described functional blocks constituting the time/date adjustment apparatus 20 may be implemented by hardware such as an integrated circuit. The time/date adjustment apparatus 20 may be implemented by a plurality of computers, and in that case, the above-described functional blocks may be distributedly deployed in the plurality of computers.

Next, FIG. 2 illustrates an example of the member information 221, the user information 222, the adjustment condition template information 223, and the time/date adjustment information (confirmation information) 224 stored in the storage unit 22.

The member information 221 includes information related to a corporate member that has conducted member registration with the time/date adjustment apparatus 20. The member information 221 includes information related to a corporate member to be added through use registration of the corporate member with the time/date adjustment apparatus 20. Specifically, the member information 221 includes a member account, an administrator privilege account, administrator authentication information, basic information, belonging member information, and site information.

The member account is information for the member administrator M or the like of the corporate member (company or the like) to log in to the time/date adjustment apparatus 20. The administrator privilege account is information for the member administrator M or the like of the corporate member (company or the like) to access the task management system 30 by using the administrator privileges. Note that the member account is desirably common to, but may be different from, the administrator privilege account (for example, an email address of the member administrator M or the like). When the member account and the administrator privilege account are common to each other, registration of the administrator privilege account with the member information 221 may be omitted.

The administrator authentication information is an access token or the like that is obtained from the task management system 30 as success results of the authentication processing when the authentication unit 211 of the time/date adjustment apparatus 20 performs the authentication processing with the task management system 30 for the first time, using the administrator privilege account. After the administrator authentication information is obtained, the authentication unit 211 can more promptly perform the authentication processing with the task management system 30 by using the administrator authentication information, without using the administrator privilege account.

The basic information is a name of the corporate member (a company name or the like) or the like. The basic information is recorded at the time of member registration, and can be changed after the member registration. The belonging member information is a list of names of belonging members belonging to a company or the like being the corporate member, user accounts for the belonging members to access the task management system 30, and the like. The belonging member information is acquired from the task management system 30 and then recorded on an assumption that the belonging members of the corporate member who may be participants of an assembly on the organizer side already use the calendar tool 31.

The site information is a list of names of sites, such as a meeting room, a reception room, and a spare room, available to the belonging members belonging to the corporate member for an assembly, identification IDs of the sites in the task management system, and the like. The site information is acquired from the task management system 30 and then recorded on an assumption that the schedules of the sites necessary for time/date adjustment are already managed by the calendar tool 31.

Note that the belonging member information and the site information are information that can be partially or entirely acquired from the task management system 30 only when the task management system 30 is accessed using the administrator privilege account, and cannot be acquired (it is to be noted that the information can be partially acquired in some cases, depending on a type of the task management system 30) when an account not having the administrator privileges is used instead of the administrator privilege account or when the task management system 30 is accessed using an account that has privileges equivalent to the administrator privilege account but is used as a user account, for example.

The user information 222 includes information related to a user who has conducted use registration of the time/date adjustment apparatus 20 among the belonging members belonging to the corporate member. The user information 222 is created when each belonging member belonging to the corporate member logs in to the time/date adjustment apparatus 20 for the first time, succeeds in the authentication processing with the task management system 30, and it is confirmed that the belonging member is included in the belonging member information of the member information 221, and is then associated with the member information 221.

The user information 222 includes a user account, user authentication information, and user basic information.

The user account is information for the user, such as the adjustment initiator A, to log in to the time/date adjustment apparatus 20. The user account is desirably common to, but may be different from, an account for the user to access the task management system 30. The following description will be given based on an assumption that the user account is common to an account for accessing the task management system 30.

The user authentication information is an access token or the like that is obtained from the task management system 30 as success results of the authentication processing when the authentication unit 211 performs the authentication processing with the task management system 30 for the first time, using the user account. After the user authentication information is obtained, the authentication unit 211 can more promptly perform the authentication processing with the task management system 30, using the user authentication information, without using the user account.

The user basic information is a name of the user or the like, and is read from the belonging member information of the member information 221 based on the user account used by the user in logging in to the time/date adjustment apparatus 20 for the first time, and is then recorded. The user basic information recorded in the user information 222 may be able to be edited by the user themselves.

The adjustment condition template information 223 is created in association with the user information 222. The adjustment condition template information 223 includes a template ID for uniquely identifying the adjustment condition template information 223, which may be a plurality of pieces of the adjustment condition template information 223, the adjustment condition (including the participant candidates, the assignment method, the assignment upper limit setting, and the like) set by the user depending on a purpose of the assembly, the booking acceptance URL, action information at the time of confirming the time/date, and screen display information (a title of the booking acceptance screen, a description, and the like).

Note that the adjustment condition template information 223 is created by the user and is thus associated with the user information 222; however, for example, the adjustment condition template information 223 may be associated with the member information 221, such that the adjustment condition template information 223 may be shared between users belonging to the corporate member corresponding to the member information 221. An adjustment condition template created by one user may be used by another user.

When the adjustment partner X selects the assembly time/date and completes a booking for an assembly, the time/date adjustment information 224 is created for each booking made by the adjustment partner X in association with the user information 222 corresponding to each user and the adjustment condition template information 223. Note that, in order for a user different from the user who has created the adjustment condition template to be able to adjust a time/date using the adjustment condition template, the time/date adjustment information 224 may be directly associated with the member information 221 of a corporate member to which the user belongs.

The time/date adjustment information 224 records the template ID, the confirmed date and time of the assembly, the participants, the information (a name, an email address, a timing of transmission of a notification email, and the like) of the adjustment partner X, a plan ID in the calendar tool 31 for the plan of the confirmed assembly, and the like.

### Processing Performed by Time/Date Adjustment System 10 at Time of Member Registration and Use Registration

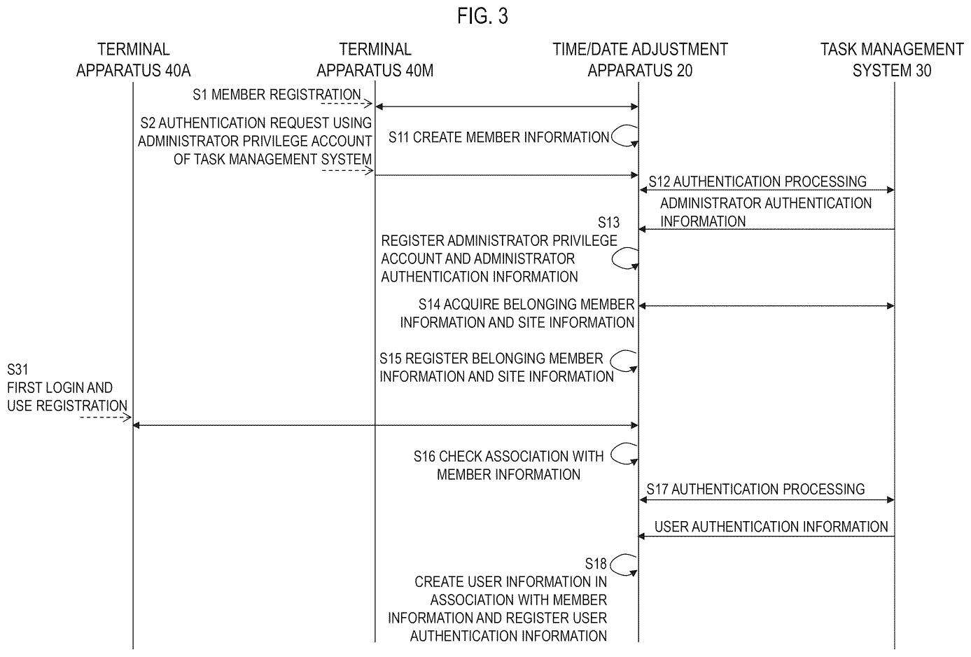

Next, FIG. 3 is a sequence diagram for illustrating an example of processing performed by the time/date adjustment system 10 at the time of member registration and use registration.

As an assumption, the calendar tool 31 provided by the task management system 30 is used for schedule management of the belonging members of the corporate member to which the adjustment initiator A and the member administrator M belong and schedule management of the sites available to the belonging members for the assembly. The task management system 30 already manages the belonging member information and the site information recorded in the member information 221. Further, the task management system 30 supplies, as its specifications, at least one of the belonging member information and the site information recorded in the member information 221 to the time/date adjustment apparatus 20, in response to a request from the time/date adjustment apparatus 20 accessed using the administrator privilege account (or the administrator authentication information).

First of all, when the member administrator M requests member registration with the time/date adjustment apparatus 20 via the network 11 by using the terminal apparatus 40M (Step S1), the authentication unit 211 of the time/date adjustment apparatus 20 creates the member information 221 and records the member information 221 in the storage unit 22 (Step S11). Note that, here, the created member information 221 includes only the member account and the basic information, and does not include the administrator privilege account, the administrator authentication information, the belonging member information, and the site information.

Next, when the member administrator M inputs the administrator privilege account for the task management system 30 and requests the authentication processing with the time/date adjustment apparatus 20 (Step S2), next, the authentication unit 211 performs the authentication processing with the task management system 30, using the administrator privilege account (Step S12).

Note that, as a modification, Steps S1 and S11 may be executed after execution of Steps S2 and S12.

Then, the administrator authentication information (access token or the like) is transmitted from the task management system 30 to the time/date adjustment apparatus 20 as success results of the authentication processing of Step S12, and thus, next, the authentication unit 211 registers the administrator privilege account and the administrator authentication information in the member information 221 created and recorded in Step S11 (Step S13). Note that, for the authentication processing, OAuth can be used, for example, and by having the member administrator M input a password to the task management system 30 temporarily without using the authentication unit 211, the administrator privilege account input by the member administrator M is authenticated by the task management system 30. The same holds true for the authentication processing performed by other persons such as the adjustment initiator A.

Next, the authentication unit 211 connects to the task management system 30 by using the administrator authentication information of the member information 221, and acquires the belonging member information and the site information of the corporate member to which the member administrator M belongs, which are managed by the task management system 30 (Step S14). Next, the authentication unit 211 registers the belonging member information and the site information acquired in Step S14 in the member information 221 created and recorded in Step S11 (Step S15).

Subsequently, when the adjustment initiator A uses the user account of the adjustment initiator A, logs in to the time/date adjustment apparatus 20 via the network 11 for the first time, and applies for use registration, using the terminal apparatus 40A (Step S31), the authentication unit 211 (of the time/date adjustment apparatus 20 checks presence of the member information 221 in which the belonging member information including the user account of the adjustment initiator A is registered, and acquires the name (user basic information) of the adjustment initiator A and the like from the belonging member information (Step S16). Next, the authentication unit 211 performs the authentication processing with the task management system 30, using the user account of the adjustment initiator A (Step S17).

Then, the user authentication information (access token or the like) is transmitted from the task management system 30 to the time/date adjustment apparatus 20 as success results of the authentication processing of Step S17, and thus, next, the authentication unit 211 creates the user information 222 corresponding to the adjustment initiator A, records the user information 222 in the storage unit 22 in association with the member information 221 checked in Step S16, and registers the user account and the user authentication information of the adjustment initiator A and the user basic information acquired in Step S16 in the user information 222 (Step S18). Through the above processing, the processing at the time of member registration and use registration ends.

According to the processing at the time of member registration and use registration described above, the member information 221 of the corporate member to which the adjustment initiator A belongs and the user information 222 of the adjustment initiator A are associated with each other. Thus, after the processing, even if the member administrator M is not logged in to the time/date adjustment apparatus 20, on the condition that the adjustment initiator A being a user is logged in to the time/date adjustment apparatus 20, for example, the time/date adjustment unit 213 of the time/date adjustment apparatus 20 can refer to and update the schedule information 311 in which action plans of the adjustment initiator A and the belonging members belonging to the same corporate member as the adjustment initiator A are registered and the schedule information 311 in which plans of assembly sites (a meeting room and the like) available to the adjustment initiator A and the belonging members belonging to the same corporate member as the adjustment initiator A are registered, which are stored in the task management system 30, via a web application programming interface (API).

Note that, in the processing at the time of member registration and use registration described above, the user information of the user belonging to the corporate member is generated, on an assumption that the member information 221 of the corporate member is present. As a modification, when an organization to which a certain individual belongs is not the corporate member and the member information 221 thereof is thus not present, the certain individual may log in to the time/date adjustment apparatus 20 and create the user information 222, and the individual may subsequently perform anew the authentication processing with the task management system 30 by using the administrator privilege account, and the member information 221 associated with the individual may be thereby generated based on the user information 222 of the individual, with the individual being regarded as the corporate member and a user account of the individual being regarded as a member account. In this case, the individual as the corporate member has the administrator privilege account, and can thus acquire the belonging member information and the site information of the organization to which the individual belongs from the task management system 30.

In the present embodiment, the belonging member information and the site information acquired from the task management system 30 are registered in the member information 221 stored in the storage unit 22; however, without the belonging member information and the site information being registered in the member information 221, the belonging member information and the site information may be acquired from the task management system 30 every time the pieces of information need to be referred to.

In the present embodiment, the belonging member information and the site information are acquired using the administrator privilege account on the task management system 30; however, when it is difficult to use the administrator privilege account of the task management system 30 from the perspective of security and the like, the belonging member information and the site information may be directly registered with the time/date adjustment apparatus 20 without using the administrator privilege account on the task management system 30. For example, the member administrator M or the user of the corporate member may directly register the belonging member information and the site information with the time/date adjustment apparatus 20 by uploading data such as an Excel (trademark) file recording the belonging member information and the site information with the time/date adjustment apparatus 20, directly inputting the data on a screen for use registration displayed on the terminal apparatus 40M or the terminal apparatus 40A by the time/date adjustment apparatus 20, or the like. By using the user account privileges of the member administrator M or the user account privileges of the user belonging to the corporate member without using the administrator privilege account, only the belonging member information and the site information that can be acquired from the task management system 30 may be acquired from the task management system 30 and registered with the time/date adjustment apparatus 20.

To address a case in which the belonging member information or the site information registered in the member information 221 needs to be edited (added, changed, and deleted), the member administrator M may log in to the time/date adjustment apparatus 20 by using the member account, cause the terminal apparatus 40M to display a belonging member information editing screen or a site information editing screen (neither of which is illustrated) through a predetermined operation, and thereby enable editing of the belonging member information or the site information.

Note that, in the belonging member information to be registered with the time/date adjustment apparatus 20 by the member administrator M, information of an outsider (an outside partner, an employee of an affiliated company, or the like) who does not belong to the same organization as the adjustment initiator A and the member administrator M can be included. In some calendar tools, when an outsider included in the belonging member information uses the same type of calendar tool as the organization to which the adjustment initiator A belongs and has special calendar sharing settings with the adjustment initiator A or the organization to which the adjustment initiator A belongs, the schedule information 311 of the outsider can be referred to and updated, using the authentication information of the adjustment initiator A and an ID for identifying the outsider in the task management system 30.

In other words, the outsider can be regarded equally as a participant in the assembly belonging to the same organization as the adjustment initiator A. Note that, even if there is an outsider in the belonging member information to be registered with the time/date adjustment apparatus 20 by the member administrator M, on the condition that the schedule information 311 managing plans of the outsider cannot be referred to with the authentication information of the adjustment initiator A, this may be regarded as an error and the outsider may be arranged not to be regarded as a participant. Note that, in the present embodiment, the outsider included in the belonging member information to be registered with the time/date adjustment apparatus 20 by the member administrator M is assumed to have special calendar sharing settings with the adjustment initiator A or the organization to which the adjustment initiator A belongs and be able to be regarded as a participant designated by the adjustment initiator A, and is described being regarded as the “belonging member belonging to the same organization as the adjustment initiator A.”

Note that, instead of acquiring the belonging member information from the task management system 30 by using the administrator privilege account on the task management system 30, for example, a certain individual member may be a corporate member administrator as the corporate member, a plurality of users including other users having conducted use registration as separate users may be collected, the member information 221 and the user information 222 may be formed with the plurality of collected users being considered as users belonging to the corporate member managed by the corporate member administrator themselves, and information of the plurality of collected users may be formed as the belonging member information of the corporate member. As methods of collecting users, for example, a collection of users may be formed by arranging the users to have an invitation relationship, which is achieved by a user having conducted use registration as an individual member transmitting an invitation notification to another user having conducted use registration with the time/date adjustment apparatus 20 as a person belonging to the same organization as the user or transmitting an invitation notification to a person not having registered with the time/date adjustment apparatus 20 and having the person newly conduct use registration with the time/date adjustment apparatus 20.

### Adjustment Condition Template Creation Processing Performed by Time/Date Adjustment System 10

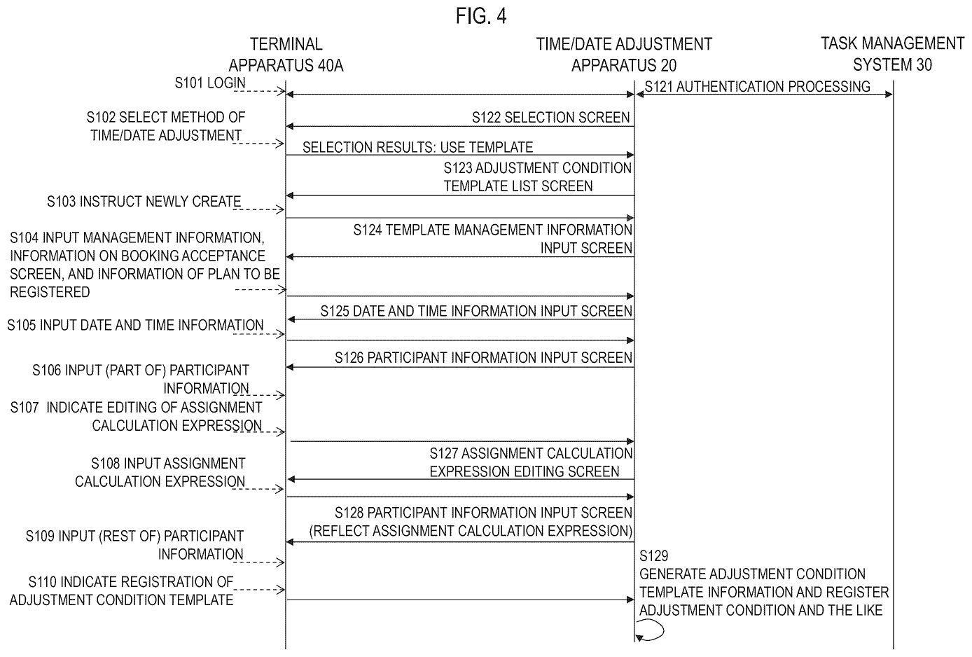

Next, FIG. 4 is a sequence diagram for illustrating an example of adjustment condition template creation processing performed by the time/date adjustment system 10.

A user such as the adjustment initiator A can create the adjustment condition templates, depending on a purpose of the assembly, such as “for a first interview for recruitment of a new graduate”, “for a second interview for recruitment of a new graduate”, “for a final interview for recruitment of a new graduate”, and “for a new business discussion”, for example.

First of all, when the adjustment initiator A logs in to the time/date adjustment apparatus 20 via the network 11, using the terminal apparatus 40A (Step S101), next, the authentication unit 211 of the time/date adjustment apparatus 20 performs the authentication processing with the task management system 30, using the user account (or the user authentication information) included in the user information 222 corresponding to the adjustment initiator A stored by the storage unit 22 (Step S121).

Next, the adjustment condition setting unit 212 of the time/date adjustment apparatus 20 causes the terminal apparatus 40A to display a selection screen (not illustrated) for selecting either “use template” or “customized adjustment” as a method of time/date adjustment (Step S122). Here, “use template” indicates a method for performing time/date adjustment using the adjustment condition template that can be repeatedly used for a plurality of assemblies on different time/dates. “Customized adjustment” indicates a method for performing time/date adjustment by setting the adjustment condition for each assembly. The following will describe a case in which the adjustment initiator A selects “use template” in detail, and description of a case of selecting “customized adjustment” will be omitted.

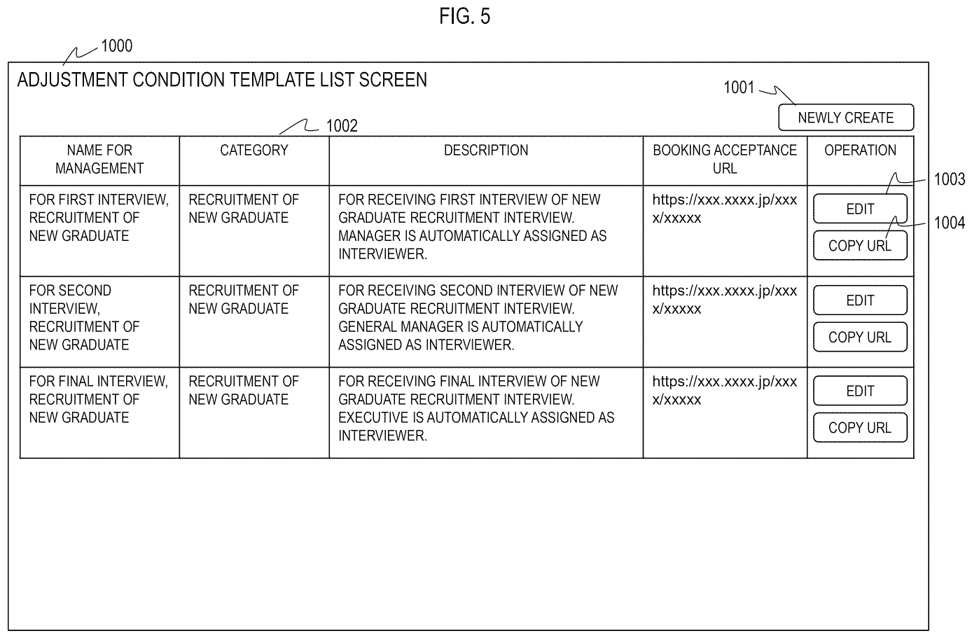

Next, when the adjustment initiator A selects “use template” as a method of time/date adjustment on the selection screen (Step S102), next, the adjustment condition setting unit 212 of the time/date adjustment apparatus 20 refers to the adjustment condition template information 223 associated with the user information 222 corresponding to the adjustment initiator A, and causes the terminal apparatus 40A to display an adjustment condition template list screen 1000 (FIG. 5) presenting a list of adjustment condition templates having been created by the current time point and being available to the adjustment initiator A (Step S123).

FIG. 5 illustrates a display example of the adjustment condition template list screen 1000 displayed in the terminal apparatus 40A. The adjustment condition template list screen 1000 is provided with a “newly create” button 1001 for instructing proceeding to a template management information input screen 1200 (FIG. 6), on which a new adjustment condition template can be created, and a template list 1002 presenting a list of adjustment condition templates available to the adjustment initiator A. In the template list 1002, a name for management, a category, a description, and a booking acceptance URL are displayed for each template. Moreover, the template list 1002 is provided with an “edit” button 1003 for instructing proceeding to a screen (not illustrated), on which a created adjustment condition template can be edited, and a “URL copy” button 1004 for instructing copying of the booking acceptance URL for each template.

FIG. 4 is referred to again. When the adjustment initiator A performs operation on the “newly create” button 1001 on the adjustment condition template list screen 1000 displayed in the terminal apparatus 40A (Step S103), next, the adjustment condition setting unit 212 causes the terminal apparatus 40A to display the template management information input screen 1200 (FIG. 6) as the adjustment condition template creation screen (Step S124).

FIG. 6 illustrates a display example of the template management information input screen 1200. The template management information input screen 1200 is provided with an input field 1201 for inputting the name for management of the template, an input field 1202 for inputting the category of the template, and an input field 1203 for inputting the purpose, the description, and the like of the template, as management information for the adjustment initiator A and a user of the corporate member to which the adjustment initiator A belongs to manage the template.

The template management information input screen 1200 is provided with an input field 1204 for inputting the screen title, an input field 1205 for inputting the booking acceptance URL, an input field 1206 for inputting a comment for the adjustment partner X, and a check box 1207 for selecting an item to request the adjustment partner X to perform input, as information on the booking acceptance screen for accepting a booking from the adjustment partner X.

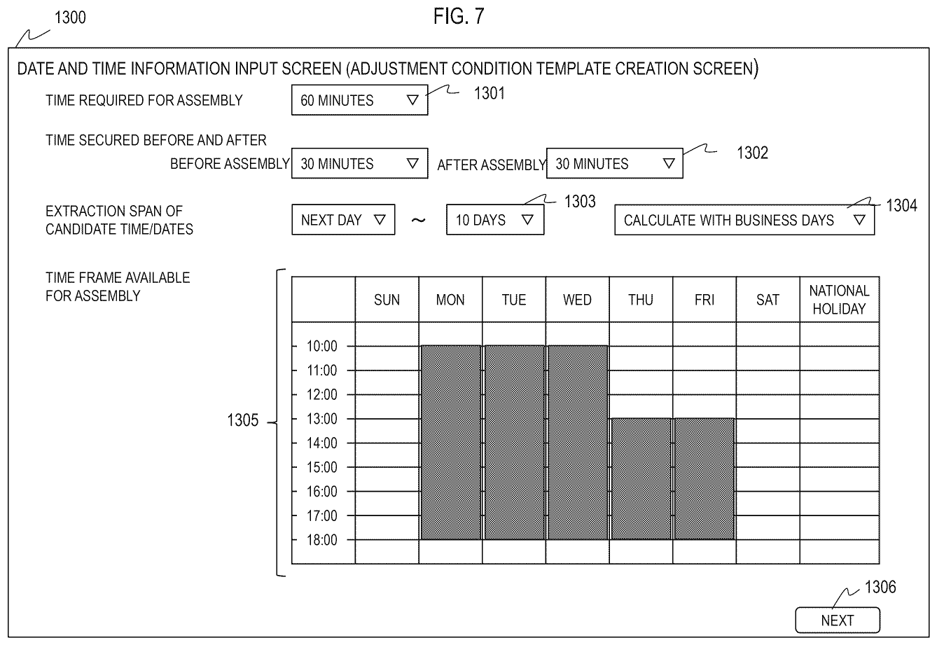

Moreover, the template management information input screen 1200 is provided with an input field 1208 for inputting a topic when the determined assembly time/date is registered with the calendar tool 31 as a plan, a check box 1209 for selecting whether or not to privately register the determined assembly time/date with the calendar tool 31 as a plan, as information of the plan to be registered, and a “next” button 1210 for indicating transition to a date and time information input screen 1300 (FIG. 7) to be displayed next.

Although the booking acceptance URL needs to be determined by the adjustment initiator A or the like to be input to the input field 1205, the adjustment condition setting unit 212 may automatically generate the booking acceptance URL to be reflected in the input field 1205. Note that, regarding the booking acceptance URL, in response to the adjustment partner X performing access based on the booking acceptance URL, the time/date adjustment unit 213 needs to be able to uniquely identify the adjustment condition template information 223 corresponding to the booking acceptance URL. Thus, at the time of creating the adjustment condition template, the adjustment condition setting unit 212 checks that the determined booking acceptance URL is unique in the time/date adjustment apparatus 20.

The adjustment condition template can accept bookings related to different assemblies from a plurality of adjustment partners by using the same adjustment condition template, and thus it is desirable that an association between each booked assembly and each adjustment partner who booked the assembly can be easily identified. Thus, in the input field 1208 for the topic of the plan to be registered, information (a company name, a name, or the like) related to the adjustment partner X that the check box 1207 has requested the adjustment partner X to input can be included. With this configuration, merely by looking at the topic of the assembly of the plan registered with the calendar tool 31, an association between the assembly and the adjustment partner of the assembly can be easily identified.

FIG. 4 is referred to again. For example, as illustrated in FIG. 6, when the adjustment initiator A inputs the management information, the information on the booking acceptance screen, and the information of the plan to be registered on the template management information input screen 1200 displayed on the terminal apparatus 40A and performs operation on the “next” button 1210 (Step S104), next, the adjustment condition setting unit 212 causes the terminal apparatus 40A to display the date and time information input screen 1300 (FIG. 7) as the adjustment condition template creation screen (Step S125).

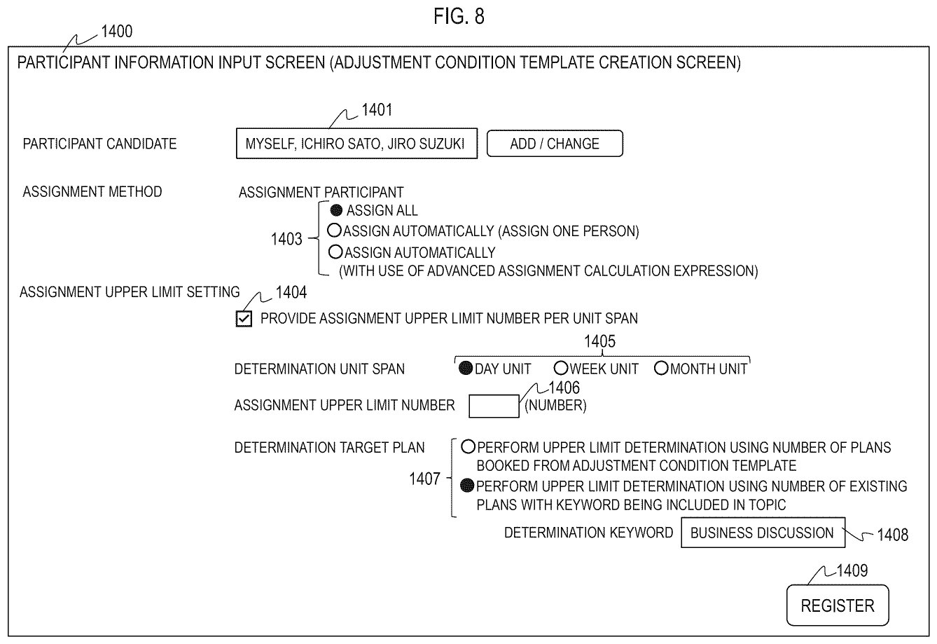

FIG. 7 illustrates a display example of the date and time information input screen 1300. The date and time information input screen 1300 is provided with a selection input field 1301 for inputting time required for the assembly, a selection input field 1302 for inputting time secured before and after the assembly, a selection input field 1303 for inputting an extraction span of the candidate time/dates, a selection input field 1304 for designating a calculation method for the extraction span, a selection input field 1305 for inputting a time frame available for the assembly for each day of the week, and a “next” button 1306 for indicating transition to a participant information input screen 1400 (FIG. 8) to be displayed next.

Here, the time secured before and after the assembly is time for movement to the site, preparation work, withdrawal work, a break, and the like, and is provided to secure time to spare for the time secured before and after between the time/date of the assembly booked using the adjustment condition template information 223 and the existing plan registered in the schedule information 311. In other words, the candidate time/date presented to the adjustment partner X using the adjustment condition template information 223 is calculated with time of the time secured before and after being provided from the existing plan.

The adjustment condition template can be repeatedly used for a plurality of assemblies on different time/dates, and as the extraction span of the candidate time/dates, a certain span with reference to the start can be designated, with the start being the timing at which the adjustment partner X accesses the booking acceptance screen by using the booking acceptance URL.

Thus, the candidate time/date presented to the adjustment partner X using the adjustment condition template information 223 is an available time/date of the participant candidate satisfying the extraction span of the candidate time/date and the time frame available for the assembly, a time/date with the time secured before and after being provided from the existing plan on the schedule information 311 of the participant candidate, and is a time/date in which the time required for the assembly can be secured during the continuous time of the candidate time/date.

FIG. 4 is referred to again. For example, as illustrated in FIG. 7, when the adjustment initiator A inputs the time required for the assembly and the like on the date and time information input screen 1300 displayed in the terminal apparatus 40A as the date and time information and performs operation on the “next” button 1306 (Step S105), next, the adjustment condition setting unit 212 causes the terminal apparatus 40A to display the participant information input screen 1400 (FIG. 8) as the adjustment condition template creation screen (Step S126).

FIG. 8 illustrates a first display example of the participant information input screen 1400. The participant information input screen 1400 is provided with a selection input field 1401 for selecting and designating one or more participant candidates (which may or may not include the adjustment initiator A) on the organizer side out of a belonging member list based on the belonging member information of the member information 221.

The participant information input screen 1400 is provided with a radio button 1403 for selecting an assignment participant being an item of the assignment method. Here, as the assignment participant, “assign all” in which all of the participant candidates are participants, “assign automatically (assign one person)” in which one of the participant candidates is a participant, or “assign automatically (with use of advanced assignment calculation expression)” can be selected.

When “assign all” is selected on the radio button 1403 as the assignment participants, further, the participant information input screen 1400 is provided with a check box 1404 for selecting whether or not to provide an assignment upper limit number per unit span, a radio button 1405 for selecting a determination unit span in counting the number of determination target plans, an input field 1406 for inputting the value of the assignment upper limit number in the determination unit span, a radio button 1407 for selecting the determination target plan, and a “register” button 1409 for registering information input on the series of adjustment condition template creation screens, as the adjustment condition template information 223, as the assignment upper limit setting for the assembly for the participant candidates. Note that each input item of the determination unit span, the assignment upper limit number, and the determination target plan is provided only when the check box 1404 is checked and the assignment upper limit number per unit span is designated.

As the determination unit span in counting the number of determination target plans, a day unit in which a calendar day is used as the determination unit span, a week unit in which seven days from Sunday to Saturday are used as the determination unit span, and a month unit in which a month starting from the first day of a calendar month is used as the determination unit span can be selected. Note that, in a case of the week unit or the month unit, the day of the week or the date as the start can be designated in some cases. As the determination unit span, any number of days, number of weeks, number of months, and the like, such as three days, two weeks, and six months, for example, can be designated in some cases.

The determination target plan means definition of the existing plans counted for each determination unit span and each participant candidate in order to compare with the assignment upper limit number, as an indicator for measuring the state of the task load of each participant candidate. In selection of the definition as the determination target plan, “perform upper limit determination using number of plans booked from adjustment condition template” or “perform upper limit determination using number of existing plans with keyword being included in topic” can be selected. When the latter is selected, an input field 1408 for inputting a determination keyword is provided.

The assignment upper limit number is an upper limit value to not accept bookings of a certain number or more of assemblies for each participant candidate in each designated determination unit span, and by limiting the number of assemblies of each participant candidate in a certain span within a certain range, the task load for each participant candidate can be prevented from being excessive.

For example, when the determination unit span is a week, the assignment upper limit number is 3, and the “perform upper limit determination using number of existing plans with keyword (business discussion) being included in topic” is selected as the definition of the determination target plan, the time/date adjustment unit 213 refers to the schedule information 311 of the participant candidate and counts the number of existing plans with (business discussion) being included in the topic for each week, and when there is a week in which the number is 3 or more, regards all of the time/dates of the week as the “time/date not being available time/date” of the participant candidate. In other words, all of the time/dates of the week are time/dates in which the assembly cannot be assigned to the participant candidate.

For example, when the determination unit span is a week, the assignment upper limit number is 3, and “perform upper limit determination using number of plans booked from adjustment condition template” is selected as the definition of the determination target plan, the time/date adjustment unit 213 refers to the time/date adjustment information 224 stored in the storage unit 22 and counts the number of pieces of time/date adjustment information 224 in which the participant candidate is the participant and the template ID of the same adjustment condition template is recorded for each week, and when there is a week in which the number is 3 or more, regards all of the time/dates of the week as the “time/date not being available time/date” of the participant candidate. In other words, all of the time/dates of the week are time/dates in which the assembly cannot be assigned to the participant candidate. Note that, not only with the time/date adjustment information 224 being referred to, the schedule information 311 may further be referred to using the plan ID recorded in the time/date adjustment information 224, a fact that the assembly confirmed via the same adjustment condition template in the past is still present in the schedule information 311 of the participant candidate without the date and time being changed may be checked, and the number of existing plans whose presence can also be checked on the schedule information 311 may be counted as the number of determination target plans.

Regarding the upper limit determination, when the team of the participant candidates includes two or more people, counting of the number of determination target plans is performed for each participant candidate constituting the team, and the maximum value in the team is regarded as the number of determination target plans of the team. In other words, for example, when three of A, B, and C are designated as the participant candidates, A, B, and C constitute one team, and the number of determination target plans in a certain determination unit span is 3 for A, 1 for B, and 4 for C, the number of determination target plans in the determination unit span of the team is the maximum value of the three, and is thus regarded as “4”, which is the same as C being the maximum value in the team.

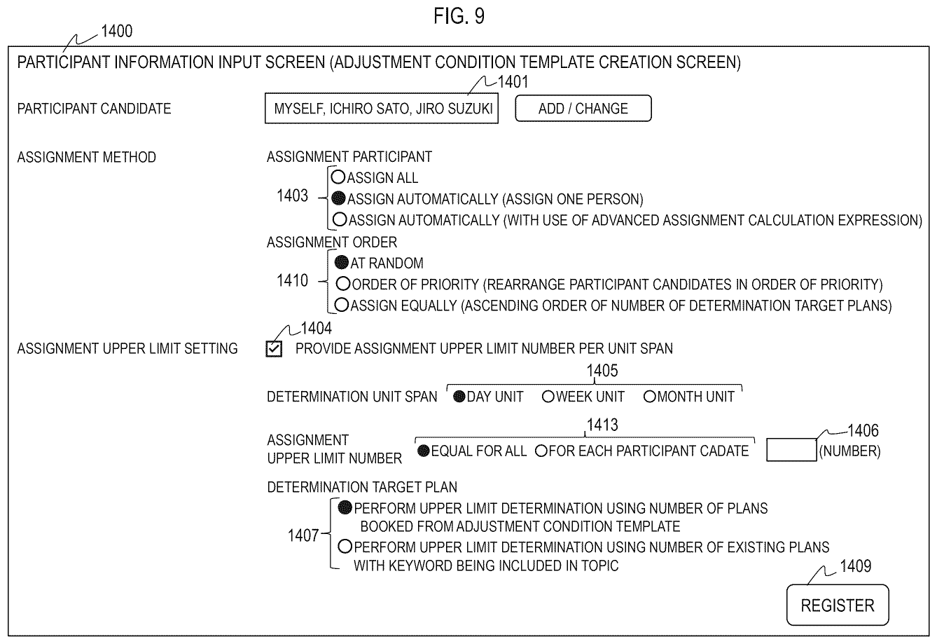

Next, FIG. 9 illustrates a second display example of the participant information input screen 1400. The second display example is a display example corresponding to a case in which, in the first display example (FIG. 8), “assign automatically (assign one person)” is selected as the assignment participant and “at random” is selected by a radio button 1410 (described later) for selecting assignment order. Note that, among the displayed items in the second display example, displayed items in common to the first display example (FIG. 8) are denoted by the same reference signs, and description thereof will be omitted as appropriate.

The second display example is similar to the first display example for the most part. Note that, in the second display example, the radio button 1410 for selecting assignment order is additionally provided in the first display example (FIG. 8) as an item of the assignment method, in response to “assign automatically (assign one person)” being selected as the assignment participant. Similarly when “assign automatically (with use of advanced assignment calculation expression)” is selected as the assignment participant (details will be described later) as well, the radio button 1410 is additionally provided.

As the assignment order, “at random” for assigning participation in the assembly to the team of participant candidates by using a random variable, “order of priority” for assigning participation in the assembly to the team of participant candidates according to order of priority set by the adjustment initiator A, or “assign equally” for assigning participation in the assembly to the team of participant candidates in ascending order of the number of determination target plans in the determination unit span can be selected on the radio button 1410.

Note that difference between “at random” “assign equally” selectable as the assignment order is that, for example, on the assumption that the ratios of the available time/dates in the schedule information 311 are similar in all of the participant candidates and the assignment upper limit numbers are also the same in all of the teams of the participant candidates, results similar to those in a case where “assign equally” is selected can be obtained in the long term when “at random” is selected, whereas deviation in assignment may be caused in the short term due to the property of the random variable. In contrast, when “assign equally” is selected, assignment can be performed equally or in a manner of becoming closer to equalization for each determination unit span.

When “order of priority” is selected as the assignment order, the order of priority of assignment to each participant candidate or each team is designated by changing the order of arrangement of each participant candidate or each team with cursor operation or the like.

Specifically, when “assign automatically (assign one person)” is selected as the assignment participant and “order of priority” is selected as the assignment order, in the selection input field 1401 for the participant candidates, the participant candidates can be rearranged with cursor operation or the like, and the order of arrangement designated in the selection input field 1401 is used as the order of priority of assignment.

When “assign automatically (with use of advanced assignment calculation expression)” is selected as the assignment participant and “order of priority” is selected as the assignment order, team units can be rearranged with cursor operation or the like in a display field 1421 (described later) for displaying the assignment calculation expression, and the order of arrangement of the teams designated in the display field 1421 is used as the order of priority of assignment.

When “assign automatically (assign one person)” is selected as the assignment participant, a radio button 1413 for selecting “equal for all” or “for each participant candidate” is added to the participant information input screen 1400 as a setting unit of the assignment upper limit number.

When “equal for all” is selected on the radio button 1413 as the setting unit of the assignment upper limit number, the input field 1406 provided in the first display example (FIG. 8) is continuously displayed, and the number input in the input field 1406 is used as the assignment upper limit number to be equally applied to all of the participant candidates.

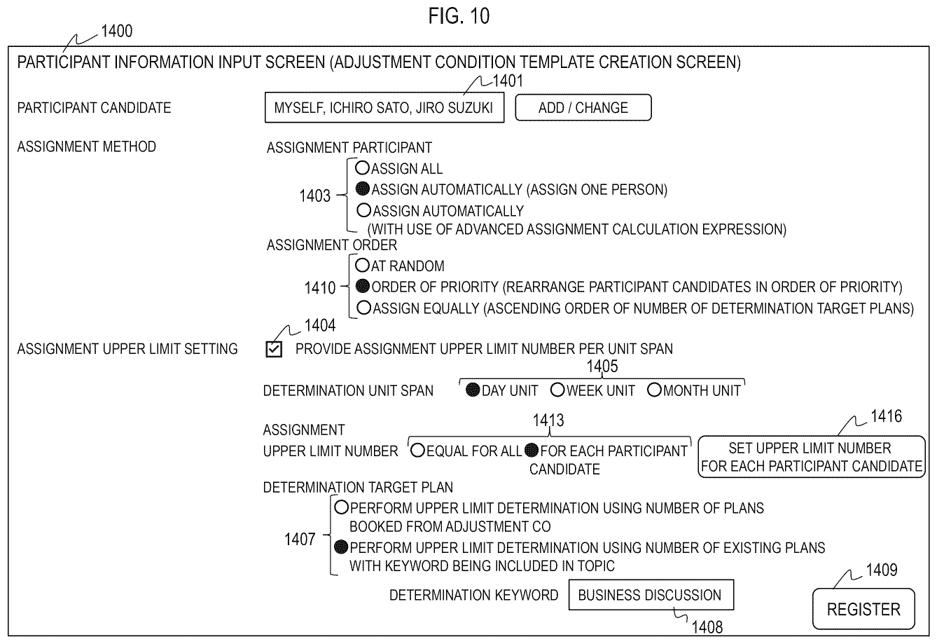

Next, FIG. 10 illustrates a third display example of the participant information input screen 1400. The third display example is a display example corresponding to a case in which, in the second display example (FIG. 9), “order of priority” is selected as the assignment order. Note that, among the displayed items in the third display example, displayed items in common to the first display example (FIG. 8) and the second display example (FIG. 9) are denoted by the same reference signs, and description thereof will be omitted as appropriate.

The third display example is similar to the second display example for the most part. Note that, as illustrated in the third display example, when “for each participant candidate” is selected as the setting unit of the assignment upper limit number, a “set upper limit number for each participant candidate” button 1416 for indicating transition to a screen (not illustrated) on which the value of the assignment upper limit number for each participant candidate can be input is provided. In the third display example, similarly to the first display example (FIG. 8), “perform upper limit determination using number of existing plans with keyword being included in topic” is selected as the definition of the determination target plan, and thus the input field 1408 for inputting the determination keyword is provided.

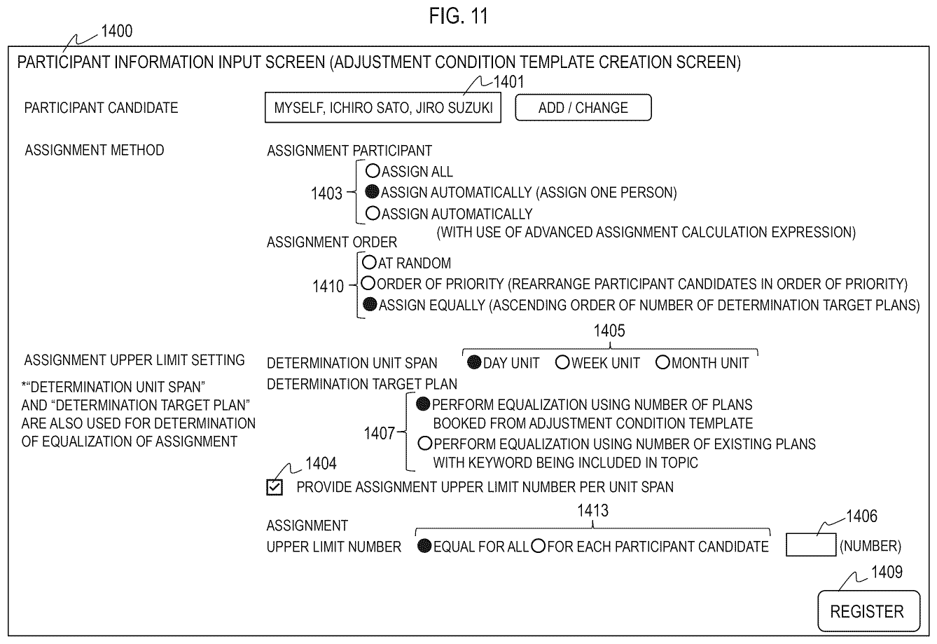

Next, FIG. 11 illustrates a fourth display example of the participant information input screen 1400. The fourth display example is a display example corresponding to a case in which, in the second display example (FIG. 9), “assign equally” is selected as the assignment order. Note that, among the displayed items in the fourth display example, displayed items in common to the first to third display examples (FIG. 8 to FIG. 10) are denoted by the same reference signs, and description thereof will be omitted as appropriate.

The fourth display example is similar to the second display example for the most part. Note that, when “assign equally” is selected as the assignment order, some of the items related to the assignment upper limit setting are items used for determination of the assignment upper limit number and are also simultaneously items used for determination of equalization of assignment, and thus display order, display control, and displayed contents of the input items related to the assignment upper limit setting are changed from when “at random” or “order of priority” is selected as the assignment order.

Specifically, the input items of the determination unit span and the determination target plan are items used for determination of the assignment upper limit number and are also simultaneously items used for determination of equalization of assignment, and thus when “assign equally” is selected as the assignment order, the input items are items invariably provided regardless of whether the check box 1404 is checked. Thus, the two items of the determination unit span and the determination target plan are arranged above the check box 1404.

The item additionally displayed in response to the check box 1404 being checked is only the item of the assignment upper limit number that is not used for determination of equalization of assignment. Thus, only the item is arranged below the check box 1404.

Moreover, the radio button 1407 for selecting definition of the determination target plan is the item also used for determination of equalization of assignment, and thus text of “perform upper limit determination” included in the options is changed to text of “equalize”. Note that, regarding the change of the text, the text is merely changed for the sake of better understanding for an operator such as the adjustment initiator A, and definition of the determination target plan is unchanged from that described above.

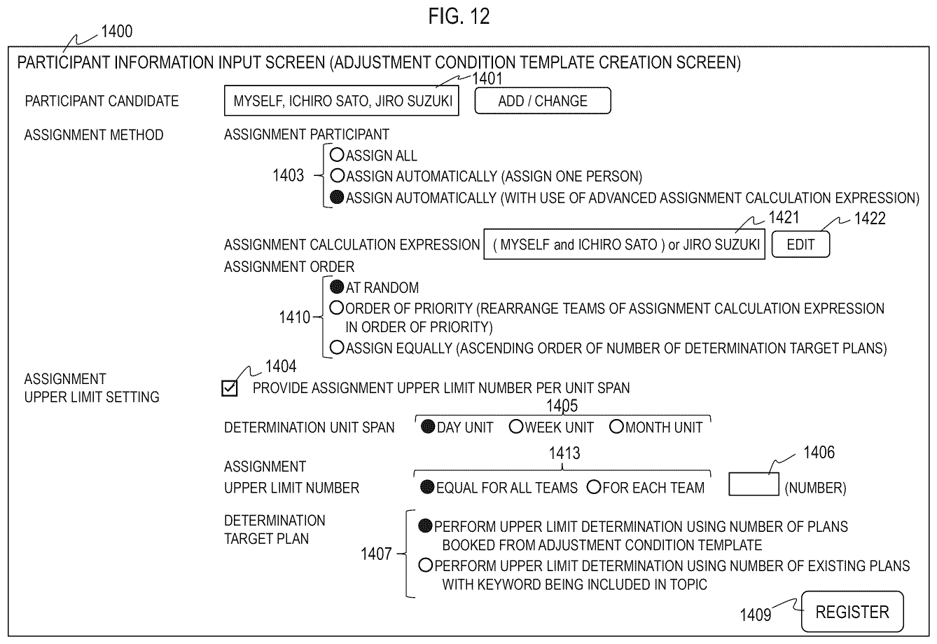

Next, FIG. 12 illustrates a fifth display example of the participant information input screen 1400. The fifth display example is a display example corresponding to a case in which, in the second display example (FIG. 9), “assign automatically (with use of advanced assignment calculation expression)” is selected as the assignment participant. Note that, among the displayed items in the fifth display example, displayed items in common to the first to fourth display examples (FIG. 8 to FIG. 11) are denoted by the same reference signs, and description thereof will be omitted as appropriate.

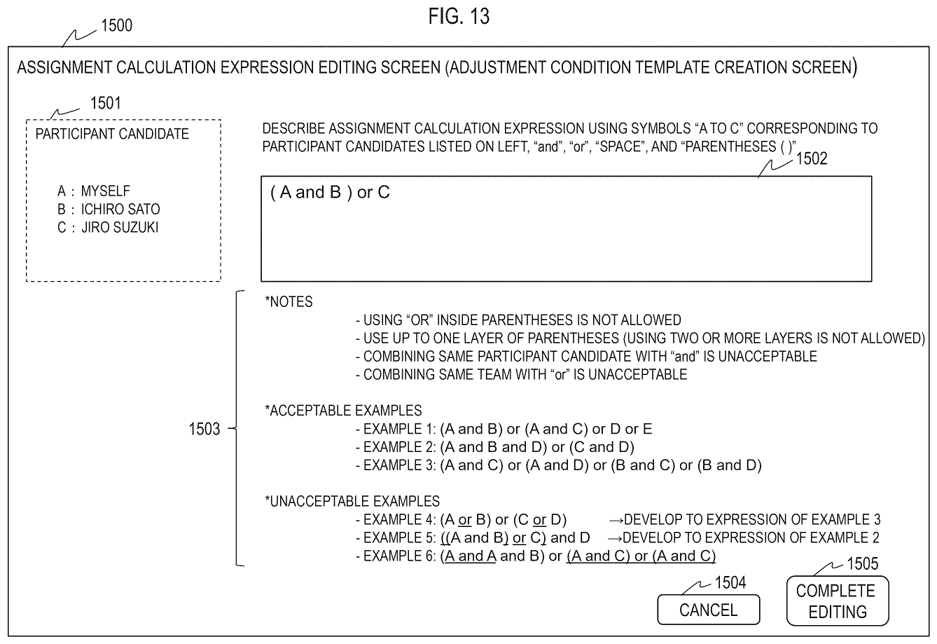

The fifth display example is similar to the second display example (FIG. 9) for the most part. Note that, in the fifth display example, as items of the assignment method, a display field 1421 for displaying the assignment calculation expression and an “edit” button 1422 for indicating transition to an assignment calculation expression editing screen 1500 (FIG. 13) allowing editing of the assignment calculation expression are added. Note that, when “assign automatically (with use of advanced assignment calculation expression)” is selected as the assignment participant, the setting unit of the assignment upper limit number is the team unit, and thus text of the radio button 1413 for selecting the setting unit of the assignment upper limit number is “equal for all teams” and “for each team”. Then, when “equal for all teams” is selected as the setting unit of the assignment upper limit number, similarly to the second display example (FIG. 9), the input field 1406 is provided, and the assignment upper limit number input in the input field 1406 is used as the assignment upper limit number to be equally applied to all of the teams. In contrast, when “for each team” is selected as the setting unit of the assignment upper limit number (not illustrated), a “set upper limit number for each team” button (not illustrated) for indicating transition to a screen (not illustrated) on which the value of the assignment upper limit number for each team can be input, which is similar to the button 1416 of the third display example (FIG. 10), is provided.

Note that, when “assign automatically (with use of advanced assignment calculation expression)” is selected as the assignment participant, the setting unit of the assignment upper limit number is the team unit, and thus the options as the setting unit of the assignment upper limit number in the fifth display example are “equal for all teams” and “for each team”; however, because the number of determination target plans for each determination unit span to be compared with the assignment upper limit number is counted for each participant candidate (details will be described later), the setting unit of the assignment upper limit number may be a participant candidate unit. Thus, even when “assign automatically (with use of advanced assignment calculation expression)” is selected as the assignment participant, the options as the setting unit of the assignment upper limit number may be “equal for all” and “for each participant candidate”, similarly to the third display example (FIG. 10) (it is to be noted that, when “for each participant candidate” is selected as the setting unit of the assignment upper limit number, the “set upper limit number for each participant candidate” button 1416 is provided similarly to the third display example (FIG. 10)).

FIG. 4 is referred to again. On the participant information input screen 1400 displayed in the terminal apparatus 40A, the adjustment initiator A inputs a part of the input items on the participant information input screen 1400 (Step S106). Specifically, the participant candidates on the organizer side are input to the selection input field 1401 on the participant information input screen 1400, and the assignment participants being an item of the assignment method are selected on the radio button 1403. Here, it is assumed that “assign automatically (with use of advanced assignment calculation expression)” is selected as the assignment participant. Next, when the adjustment initiator A performs operation on the “edit” button 1422 on the participant information input screen 1400 and indicates display of the assignment calculation expression editing screen 1500 (FIG. 13) (Step S107), next, the adjustment condition setting unit 212 causes the terminal apparatus 40A to display the assignment calculation expression editing screen 1500 (FIG. 13) as the adjustment condition template creation screen (Step S127).

FIG. 13 illustrates a display example of the assignment calculation expression editing screen 1500. The assignment calculation expression editing screen 1500 is provided with a display field 1501 for giving symbols such as A, B, and C to the participant candidates input to the selection input field 1401 on the participant information input screen 1400 for display, an input field 1502 for inputting and editing the assignment calculation expression by using the symbols given to the participant candidates, a display field 1503 for displaying rules related to the assignment calculation expression, a “cancel” button 1504 for indicating cancelation of editing of the assignment calculation expression, and a “complete editing” button 1505 for finishing editing of the assignment calculation expression and indicating transition to the participant information input screen 1400 reflecting the edited assignment calculation expression.

The assignment calculation expression input and edited in the input field 1502 is a so-called logical expression, and performs team division of the participant candidates through description using the symbols (A, B, C, and the like) given to the participant candidates, “and”, “or”, “space”, and “parentheses ( )”. The participant candidates constituting the same team are designated by combining the symbols such as A, B, and C with “and”, and segmentation of the teams is designated by separating with “or”.

Specifically, for example, the assignment calculation expression, such as “(A and B) or C”, “A or (A and B)”, “(A and B) or (A and C)”, “(A and B) or (C and D)”, “(A and B) or (B and C) or (C and A)”, “(A and B) or (A and C) or D”, “(A and B) or (A and C) or (D and B) or (D and C)”, and “(A and B) or (A and C) or (D and E) or (D and F)”, can be described. In other words, regarding a plurality of teams, each team is configured by determining each of the participant candidates constituting each team. Note that, regarding the assignment calculation expression, at least one team includes a plurality of participant candidates. A certain participant candidate may belong to a plurality of different teams.

On the assumption that a certain participant candidate may belong to a plurality of different teams, because the assignment calculation expression is a logical expression that can freely create team divisions by using “and”, “or”, and “parentheses ( )”, team divisions of all assumable patterns can be designated. In other words, for example, the assignment calculation expression allows for designation of all possible team divisions in business situations, such as “team division of a case in which the numbers of people constituting all of the teams are not the same”, “team division of a case in which one team is configured by freely combining one boss and one subordinate out of one or more bosses and a plurality of subordinates”, and “team division of a case in which one team includes three or more people by selecting at least one person from each of three departments”, not to mention “simple team division of a case in which the numbers of people constituting all of the teams are the same and each participant candidate belongs to only one team”.

In the case of the assignment calculation expression “(A and B) or C” illustrated in FIG. 13, the participant candidates A, B, and C are subjected to team division into two teams of the team (AB) including two participant candidates A and B and the team (C) including only one participant candidate C.

Note that, when “assign all” or “assign automatically (assign one person)” is selected as the assignment participant on the participant information input screen 1400, the display field 1421 for displaying the assignment calculation expression and the “edit” button 1422 for indicating transition to the assignment calculation expression editing screen 1500 (FIG. 13) are not displayed, but the assignment calculation expression is automatically set as internal processing.

For example, on the participant information input screen 1400, when the three of A, B, and C are designated as the participant candidates and “assign all” is selected as the assignment participants, team division is performed, considering that the assignment calculation expression “A and B and C” is set. In this case, the participant candidates A, B, and C are subjected to team division into one team of the team (ABC) including all of the participant candidates A, B, and C. For example, on the participant information input screen 1400, when the three of A, B, and C are designated as the participant candidates and “assign automatically (assign one person)” is selected as the assignment participants, team division is performed considering that the assignment calculation expression “A or B or C” is set. In this case, the participant candidates A, B, and C are subjected to team division into three teams of the teams (A), (B), and (C) including only one person from each of the participant candidates A, B, and C.

In other words, selecting “assign all” as the assignment participant on the participant information input screen 1400 means designation of setting of the assignment calculation expression (for example, “A and B and C”) in which all of the participant candidates are connected with “and”. Selecting “assign automatically (assign one person)” as the assignment participant on the participant information input screen 1400 means designation of setting of the assignment calculation expression (for example, “A or B or C”) in which all of the participant candidates are connected with “or”.

Note that, in the present embodiment, team division of the participant candidates is performed using the assignment calculation expression editing screen 1500 (FIG. 13); however, team division may be performed without using the assignment calculation expression. For example, an icon or the like representing each participant candidate may be displayed on a team division screen (not illustrated) instead of the assignment calculation expression editing screen 1500, each icon may be allowed to be moved with cursor operation or duplicated, areas respectively corresponding to a plurality of teams may be provided on the team division screen, and the icons corresponding to the participant candidates may be moved to the areas of the teams, so as to allow the participant candidates to be divided into the plurality of teams. For example, in the area of each team provided on the team division screen, a selection input field for designating one or more participant candidates constituting the team may be provided.

FIG. 4 is referred to again. When the adjustment initiator A inputs and edits the assignment calculation expression on the assignment calculation expression editing screen 1500 displayed in the terminal apparatus 40A and performs operation on the “complete editing” button 1505 (Step S108), next, the adjustment condition setting unit 212 causes the terminal apparatus 40A to display the participant information input screen 1400 reflecting the input and edited assignment calculation expression (Step S128).

Note that, when Step S107 subsequent to Step S106 is not performed, in other words, “assign automatically (with use of advanced assignment calculation expression)” is not selected as the assignment participant on the participant information input screen 1400 and “assign all” or “assign automatically (assign one person)” is selected in Step S106, Steps S127, S108, and S128 are omitted.

Next, on the participant information input screen 1400 displayed in the terminal apparatus 40A, when the adjustment initiator A finishes inputting and selecting uninput items of the participant information (Step S109) and performs operation on the “register” button 1409 (Step S110), the adjustment condition setting unit 212 newly generates the adjustment condition template information 223 in association with the user information 222 of the adjustment initiator A and causes the storage unit 22 to store the adjustment condition template information 223, and registers various pieces of information input on the adjustment condition template creation screen in the adjustment condition template information 223 (Step S129). Through the above, the adjustment condition template creation processing ends.

According to the adjustment condition template creation processing described above, the adjustment condition template that can be repeatedly used again and again for time/date adjustment of different assemblies and includes the adjustment condition including the participant candidates, the assignment method, and the assignment upper limit setting, the booking acceptance URL, and the like can be created.

### Time/Date Adjustment Processing Using Adjustment Condition Template

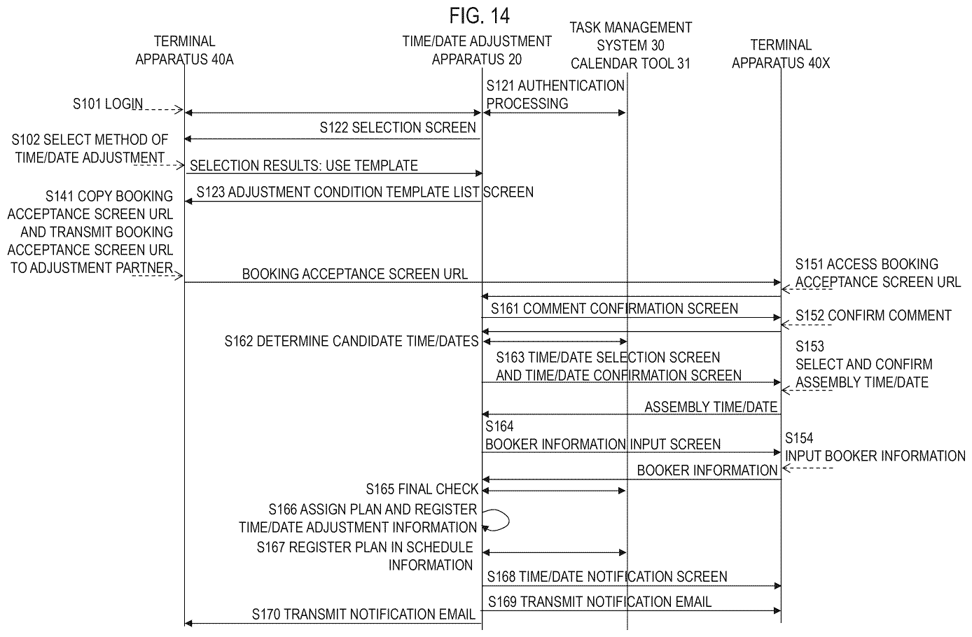

Next, FIG. 14 is a sequence diagram for illustrating an example of the time/date adjustment processing using the adjustment condition template created through the adjustment condition template creation processing illustrated in FIG. 4.

The time/date adjustment processing includes Steps S101, S121, S122, S102, and S123 similar to those of the adjustment condition template creation processing illustrated in FIG. 4.

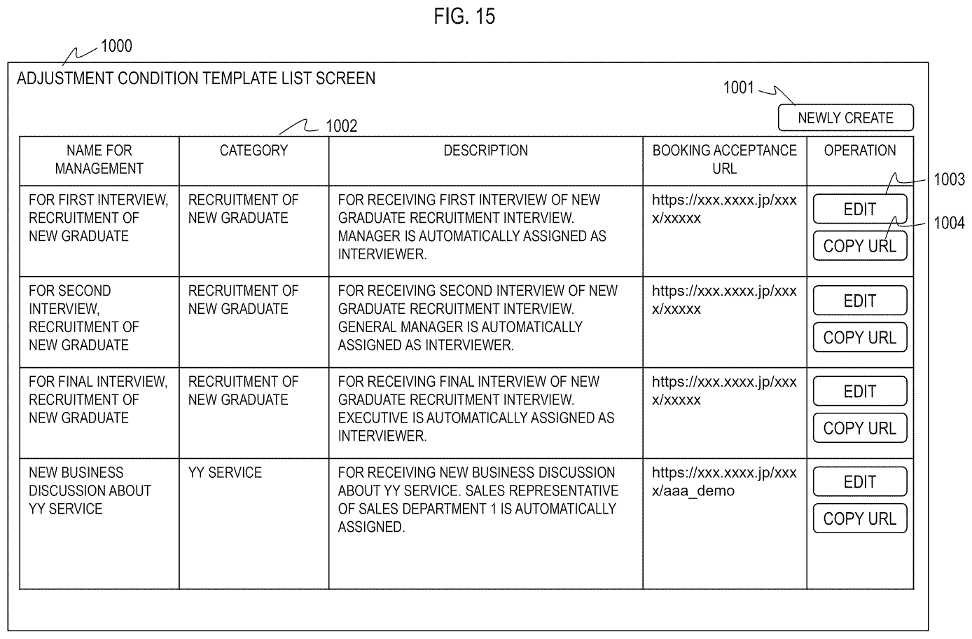

FIG. 15 illustrates a display example of the adjustment condition template list screen 1000 displayed in the terminal apparatus 40A in Step S123. The adjustment condition template list screen 1000 of FIG. 15 is a screen in which the adjustment condition template with the name for management “new business discussion about YY service” is added to the adjustment condition template list screen 1000 of FIG. 5, due to the adjustment condition template creation processing described above.

FIG. 14 is referred to again. Next, on the adjustment condition template list screen 1000 (FIG. 15), the adjustment initiator A performs operation on the “URL copy” button 1004 in the adjustment condition template with the name for management “new business discussion about YY service” to copy the booking acceptance URL, pastes the booking acceptance URL to an electronic mail or the like, and transmits the booking acceptance URL to the terminal apparatus 40X of the adjustment partner X (Step S141). Note that, instead of or in addition to transmitting the booking acceptance URL to the adjustment partner X by using an electronic mail or the like, the booking acceptance URL may be disclosed on a website or the like on the organizer side, for example. In the following, operation of the adjustment initiator A is not required.

Next, when the adjustment partner X accesses the booking acceptance URL by using the terminal apparatus 40X (Step S151), the time/date adjustment unit 213 causes the terminal apparatus 40X to display a comment confirmation screen 1600 (FIG. 16) as the booking acceptance screen (Step S161).

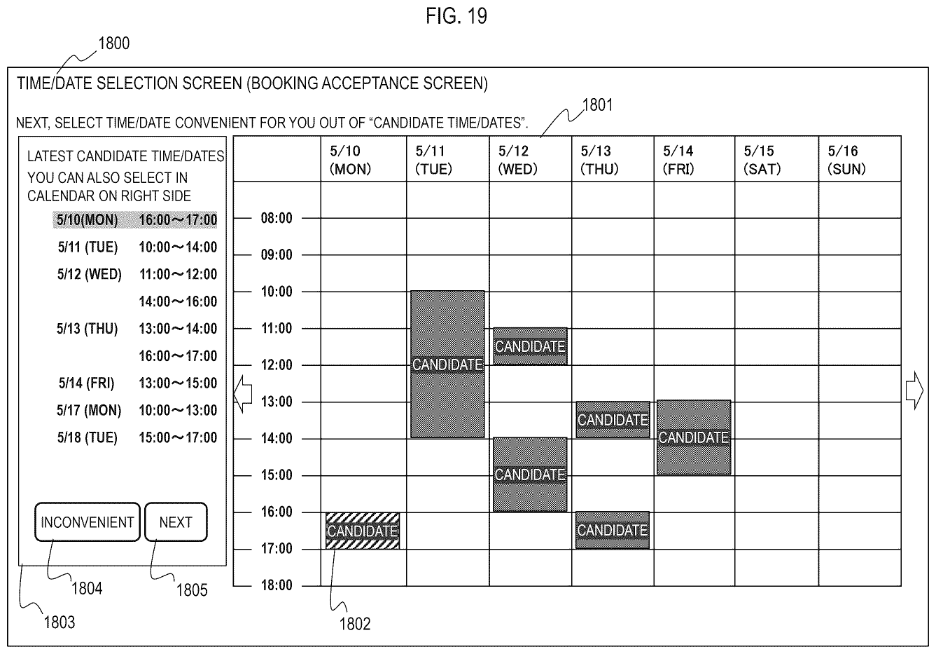

FIG. 16 illustrates a display example of the comment confirmation screen 1600. On the comment confirmation screen 1600, a comment from the organizer or the like is displayed as information related to the assembly input by the adjustment initiator A. The comment confirmation screen 1600 is provided with a check box 1601 for checking when a comment from the organizer is confirmed and a “select time/date” button 1602 for instructing proceeding to a time/date selection screen 1800 (FIG. 19) on which a time/date for booking can be selected.

Note that, in the present embodiment, although only a one-way comment on the organizer side for the adjustment partner X is displayed on the comment confirmation screen 1600, a comment from the adjustment partner X in response to the comment from the organizer can be input on the comment confirmation screen 1600. When the adjustment initiator A creates the adjustment condition template, whether or not the comment from the adjustment partner X can be input can be set.

FIG. 14 is referred to again. Next, when the adjustment partner X checks the check box 1601 on the comment confirmation screen 1600 and performs operation on the “select time/date” button 1602 (Step S152), the time/date adjustment unit 213 reads the adjustment condition (the time required for the assembly, the time secured before and after, the extraction span of the candidate time/dates, the time frame available for the assembly, the participant candidates, the assignment method (including the assignment calculation expression), and the assignment upper limit setting) from the adjustment condition template information 223 of the adjustment initiator A corresponding to the booking acceptance URL, and divides the participant candidates into teams according to the assignment calculation expression. The time/date adjustment unit 213 refers to the schedule information 311 of the participant candidates managed by the calendar tool 31, extracts common available time/dates satisfying the adjustment conditions (the time required for the assembly, the time secured before and after, the extraction span of the candidate time/dates, the time frame available for the assembly, and the assignment upper limit setting) of all of the participant candidates constituting the team as the first candidate time/dates for each team, and determines the time/dates being the first candidate time/dates of at least one team as the second candidate time/dates (Step S162).

Note that, when the assignment upper limit number as the assignment upper limit setting is set (the check box 1404 on the participant information input screen 1400 is checked), the time/date adjustment unit 213 refers to one of or both of the schedule information 311 and the time/date adjustment information 224 of the participant candidates, and counts the number of determination target plans for each determination unit span in each participant candidate. Then, when the number of determination target plans of a certain participant candidate in a certain determination target span is equal to or more than the assignment upper limit number, all of the time/dates of the participant candidate in the determination target span are regarded as the “time/date not being available time/date”. In other words, there are not common available time/dates of all of the participant candidates of the team to which the participant candidate belongs, and thus there are not first candidate time/dates of the team to which the participant candidate belongs in the determination target span either.

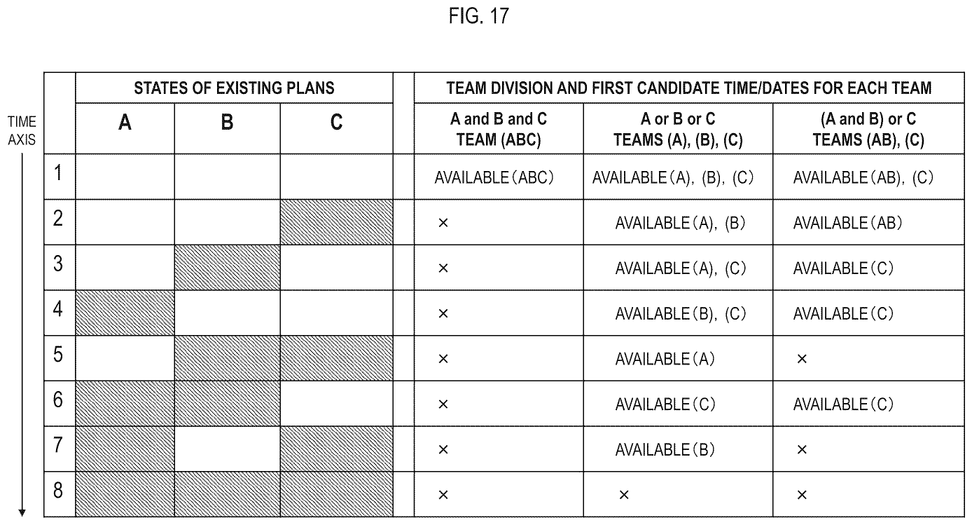

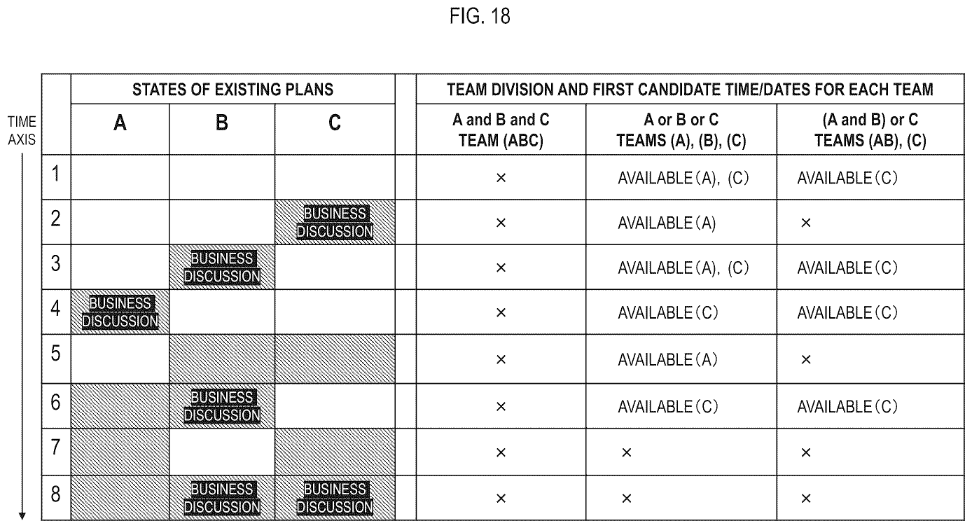

The processing of Step S162 will be described in detail with reference to FIG. 17 and FIG. 18.

FIG. 17 is a diagram for illustrating an example of team division using the assignment calculation expression and a method of determining the second candidate time/dates when there is not designation of the assignment upper limit number.

As illustrated in the figure, it is assumed that the participant candidates are the three of A, B, and C. The states of the existing plans in the figure indicate the states of the existing plans registered in the schedule information 311 of each participant candidate in the time frames available for the assembly of one day included in the extraction span of the candidate time/dates.

As illustrated in the figure, a case is assumed in which there are existing plans (hatched time frames in the figure) in time frames 4, 6, 7, and 8 for participant candidate A, there are existing plans in time frames 3, 5, 6, and 8 for participant candidate B, and there are existing plans in time frames 2, 5, 7, and 8 for participant candidate C. For the sake of convenience of description, the time secured before and after included in the adjustment condition is 0 minutes.

For example, when “assign all” is selected as the assignment participant in the assignment method, the assignment calculation expression “A and B and C” is applied, and the participant candidates A, B, and C are subjected to team division into one team of the team (ABC). In this case, common available time/dates of the participant candidates A, B, and C constituting the team (ABC) is only time frame 1, and thus only time frame 1 is the first candidate time/date of the team (ABC). Then, because there is no other team, time frame 1 being the first candidate time/date of the team (ABC) is the second candidate time/date.

For example, when “assign automatically (assign one person)” is selected as the assignment participant in the assignment method, the assignment calculation expression “A or B or C” is applied, and the participant candidates A, B, and C are subjected to team division into three teams of the teams (A), (B), and (C). In this case, available time/dates of the participant candidate A constituting team (A) are time frames 1, 2, 3, and 5, and thus time frames 1, 2, 3, and 5 are the first candidate time/dates of the team (A). Available time/dates of the participant candidate B constituting the team (B) are time frames 1, 2, 4, and 7, and thus time frames 1, 2, 4, and 7 are the first candidate time/dates of the team (B). Moreover, available time/dates of the participant candidate C constituting the team (C) are time frames 1, 3, 4, and 6, and thus time frames 1, 3, 4, and 6 are the first candidate time/dates of the team (C). Then, time frames 1, 2, 3, 4, 5, 6, and 7 being the first candidate time/dates of at least one team of the three teams (A), (B), and (C) are the second candidate time/dates.

Moreover, for example, when “assign automatically (with use of advanced assignment calculation expression)” is selected as the assignment participant in the assignment method and the assignment calculation expression “(A and B) or C” is set, for example, the participant candidates A, B, and C are subjected to team division into two teams of the teams (AB) and (C). In this case, common available time/dates of the participant candidates A and B constituting the team (AB) are time frames 1 and 2, and thus time frames 1 and 2 are the first candidate time/dates of the team (AB). Available time/dates of the participant candidate C constituting the team (C) are time frames 1, 3, 4, and 6, and thus time frames 1, 3, 4, and 6 are the first candidate time/dates of the team (C). Then, time frames 1, 2, 3, 4, and 6 being the first candidate time/dates of at least one team of the two teams (AB) and (C) are the second candidate time/dates.

Next, FIG. 18 is a diagram for illustrating an example of team division using the assignment calculation expression and the method of determining the second candidate time/dates when there is designation of the assignment upper limit number. Specifically, the description continues on the assumption that the determination unit span is “day unit”, the assignment upper limit number is 3 being equal for all or equal for teams, and the determination target plan is set as “perform upper limit determination using number of existing plans with keyword “business discussion” being included in topic”.

FIG. 18 is similar to the FIG. 17 for the most part, and thus description of similar details will be omitted. Note that, the time frames described with “business discussion” in the time frames of the existing plans indicate that the existing plans (hereinafter referred to as existing plans “business discussion”) with the keyword “business discussion” being included in the topic are registered.

In the case of the figure, for the participant candidate B, there are already three existing plans with the keyword “business discussion” being included in the topic on the day, and thus the number reaches 3 being the assignment upper limit number of the day unit. Thus, it is considered that there are not available time/dates of the teams (A, B, C), (B), and (AB) to which the participant candidate B belongs on the day, and thus there are not first candidate time/dates of the teams (A, B, C), (B), and (AB) to which the participant candidate B belongs on the day.

For example, when “assign all” is selected as the assignment participant in the assignment method, the assignment calculation expression “A and B and C” is applied, and the participant candidates A, B, and C are subjected to team division into one team of the team (ABC). In this case, as described above, there are not first candidate time/dates of the team (ABC), and thus there are not second candidate time/dates either.

For example, when “assign automatically (assign one person)” is selected as the assignment participant in the assignment method, the assignment calculation expression “A or B or C” is applied, and the participant candidates A, B, and C are subjected to team division into three teams of the teams (A), (B), and (C). In this case, the first candidate time/dates of the team (A) are time frames 1, 2, 3, and 5, similarly to FIG. 17. There are not first candidate time/dates of the team (B) as described above. Moreover, the first candidate time/dates of the team (C) are time frames 1, 3, 4, and 6, similarly to FIG. 17. Then, time frames 1, 2, 3, 4, 5, and 6 being the first candidate time/dates of at least one team of the three teams (A), (B), and (C) are the second candidate time/dates.

Moreover, for example, when “assign automatically (with use of advanced assignment calculation expression)” is selected as the assignment participant in the assignment method and the assignment calculation expression “(A and B) or C” is set, the participant candidates A, B, and C are subjected to team division into two teams of the teams (AB) and (C). In: this case, there are not first candidate time/dates of the team (AB) as described above.

The first candidate time/dates of the team (C) are time frames 1, 3, 4, and 6, similarly to FIG. 17. Then, time frames 1, 2, 4, and 6 being the first candidate time/dates of at least one team of the two teams (AB) and (C) are the second candidate time/dates.

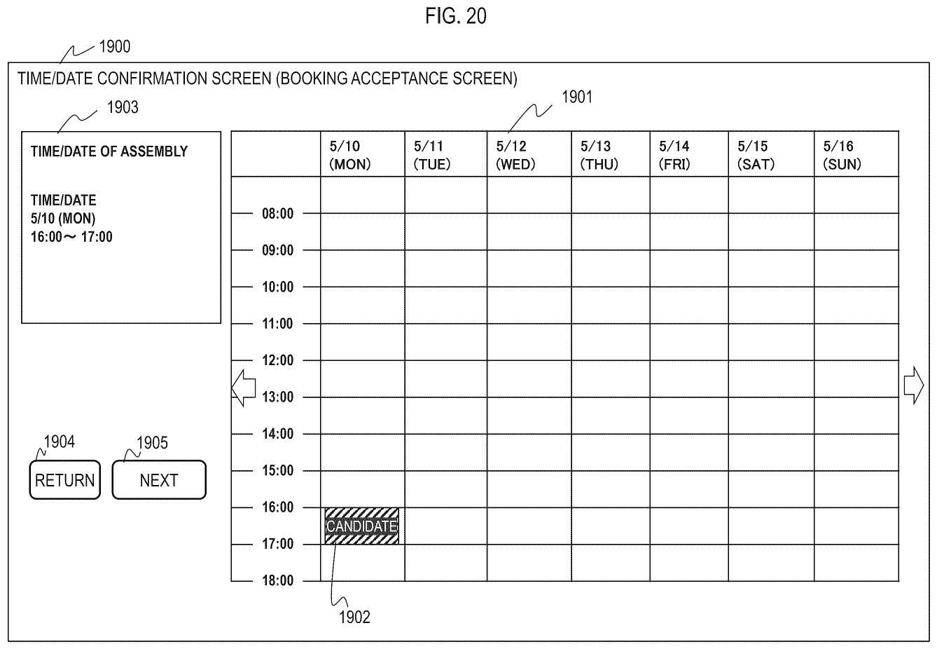

FIG. 14 is referred to again. Next, in order to present the determined second candidate time/dates to the adjustment partner X for selection, the time/date adjustment unit 213 causes the terminal apparatus 40X to sequentially display the time/date selection screen 1800 (FIG. 19) and a time/date confirmation screen 1900 (FIG. 20) as the booking acceptance screens (Step S163).

FIG. 19 illustrates a display example of the time/date selection screen 1800. On the time/date selection screen 1800, a calendar 1801 displayed in a grid pattern with its horizontal axis representing dates and vertical axis representing time and a candidate time/date list 1803 in which the second candidate time/dates are listed are displayed. The time/date selection screen 1800 is provided with an “inconvenient” button 1804 on which operation is performed when the second candidate time/dates presented on the time/date selection screen 1800 are inconvenient and a “next” button 1805 for confirming the selected assembly time/date.

In the calendar 1801, candidate time/date frames 1802 presenting the second candidate time/dates are displayed in different colors or the like so that the candidate time/date frames 1802 can be distinguished from other frames. The adjustment partner X can select the assembly time/date by selecting one of the candidate time/date frames 1802 in the calendar 1801 or one of the second candidate time/date frames in the candidate time/date list 1803.

When the adjustment partner X performs operation on the “inconvenient” button 1804, the time/date adjustment unit 213 suspends the time/date adjustment processing currently in process, and notifies the adjustment initiator A that the adjustment partner X has performed operation on the “inconvenient” button 1804. When the adjustment partner X selects the assembly time/date and performs operation on the “next” button 1805, the time/date adjustment unit 213 displays, for the terminal apparatus 40X, the time/date confirmation screen 1900 (FIG. 20) for confirming the assembly time/date selected by the adjustment partner X themselves.

In the present case, for example, it is assumed that the adjustment partner X selects the candidate time/date from 16:00 to 17:00 on May 10th (Monday) as the assembly time/date and performs operation on the “next” button 1805 on the time/date selection screen 1800 (FIG. 19).

Next, FIG. 20 illustrates a display example of the time/date confirmation screen 1900. On the time/date confirmation screen 1900, a calendar 1901 displayed in a grid pattern with its horizontal axis representing dates and vertical axis representing time and an assembly time/date 1903 are displayed.

In the calendar 1901, on the time/date selection screen 1800, an assembly time/date frame 1902 presenting an assembly time/date selected by the adjustment partner X themselves is displayed in different colors or the like so that the assembly time/date frame 1902 can be distinguished from other frames. In the assembly time/date 1903, the assembly time/date selected by the adjustment partner X is displayed.

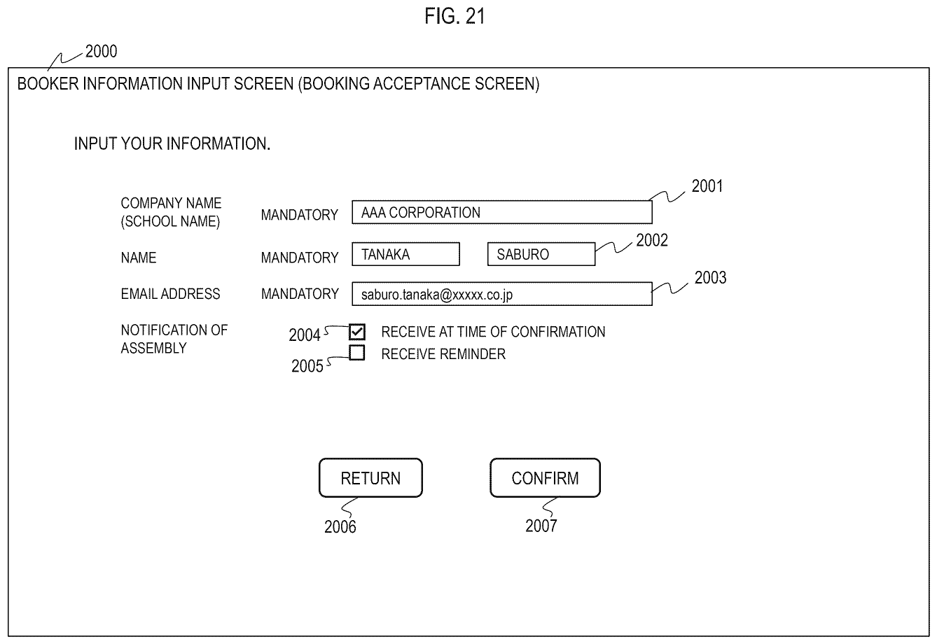

The time/date confirmation screen 1900 is provided with a “return” button 1904 for returning back to the time/date selection screen 1800 (FIG. 19) and a “next” button 1905 for proceeding to a booker information input screen 2000 (FIG. 21).

FIG. 14 is referred to again. When the adjustment partner X performs operation on the “next” button 1905 on the time/date confirmation screen 1900 (FIG. 20) displayed in the terminal apparatus 40X (Step S153), next, the time/date adjustment unit 213 causes the terminal apparatus 40X to display the booker information input screen 2000 (FIG. 21) as the booking acceptance screen for causing the adjustment partner X to input the booker information (Step S164).

FIG. 21 illustrates a display example of the booker information input screen 2000. The booker information input screen 2000 is provided with items for the adjustment initiator A to request the adjustment partner X set in the check box 1207 on the template management information input screen 1200 to perform input, and is provided with an input field 2001 for the adjustment partner X to input a company name (school name), an input field 2002 for inputting a name, and an input field 2003 for inputting an email address in the display example. The booker information input screen 2000 is provided with check boxes 2004 and 2005 for designating a timing of notification of a notification email to perform notification of assembly details, a “return” button 2006 for returning back to the time/date confirmation screen 1900, and a “confirm” button 2007 for indicating input confirmation on the booker information input screen 2000 and a series of operation confirmations on the booking acceptance screens.

FIG. 14 is referred to again. When the adjustment partner X inputs their booker information (a company name (school name), a name, an email address) and performs operation on the “confirm” button 2007 on the booker information input screen 2000 (Step S154), next, the time/date adjustment unit 213 performs final check that the assembly time/date that the adjustment partner X is to confirm is still available for booking at the current time point (Step S165).

Specifically, the time/date adjustment unit 213 refers to the schedule information 311 of the participant candidates managed by the calendar tool 31, and performs final check that the assembly time/date to be confirmed is a common available time/date satisfying the adjustment conditions of all of the participant candidates constituting the team of at least one team. Note that, because assignable teams are already confirmed in in Step S162, the final check of the available time/date may be performed only for the assignable teams.

For example, when the assembly time/date to be confirmed by the adjustment partner X is no longer the common available time/date satisfying the adjustment conditions of all of the participant candidates constituting the team in all of the teams, for example, a message such as “The selected time/date has been occupied. Select the time/date again,” may be displayed in the terminal apparatus 40X, and the processing may be returned back to Step S162 and resumed from the operation of the adjustment partner X on the time/date selection screen 1800.

In contrast, when it is checked that the assembly time/date to be confirmed is a common available time/date satisfying the adjustment conditions of all of the participant candidates constituting the team of at least one team, the time/date adjustment unit 213 assigns participation in the assembly to the team that can be assigned the assembly plan according to assignment order of the assignment method included in the adjustment condition. Then, the time/date adjustment unit 213 newly registers the time/date adjustment information 224 as information in which the adjustment partner X has completed a booking, in association with the user information 222 of the adjustment initiator A and the used adjustment condition template information 223 (Step S166).

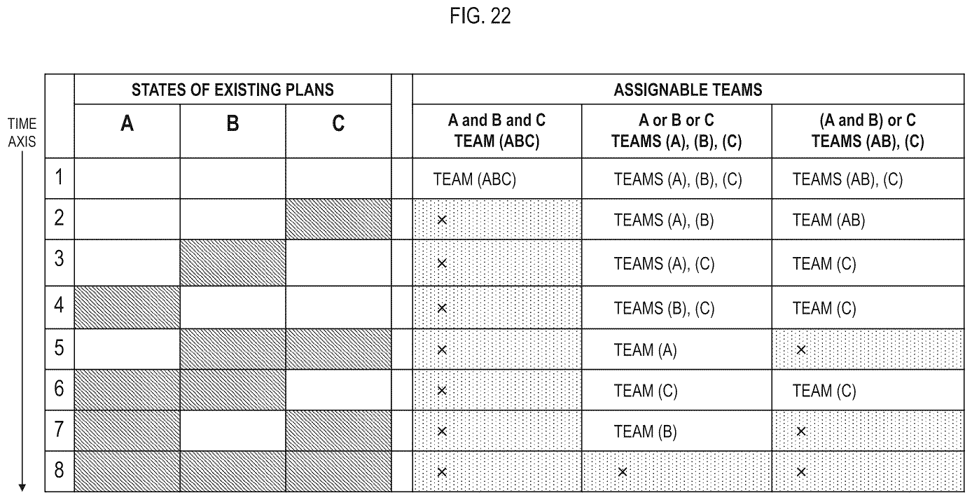

The processing of Step S166 will be described in detail with reference to FIG. 22 to FIG. 25. As illustrated in each figure, it is assumed that the participant candidates are the three of A, B, and C. The states of the existing plans in each figure indicate the states of the existing plans registered in the schedule information 311 of each participant candidate in the time frames available for the assembly of one day included in the extraction span of the candidate time/dates at the time point of Step S166. Note that description continues on the assumption that the states of the existing plans are unchanged from the time point of Step S162.

FIG. 22 is a diagram for illustrating an example of teams that can be assigned the assembly and the assignment method corresponding to a case in which the assignment order is at random or the order of priority and the assignment upper limit number is not provided. Note that the team division, the states of the existing plans of the participant candidates A, B, and C, and the setting related to the assignment upper limit number are similar to those of FIG. 17, and thus the second candidate time/dates presented to the adjustment partner X are also similar to those of FIG. 17. Thus, the time frames described with “x” are not included in the second candidate time/dates presented to the adjustment partner X, and are not selected by the adjustment partner X as the assembly time/dates.

When “assign all” is selected as the assignment participant in the assignment method, the team of the participant candidates is only the team (ABC), and only the team (ABC) is assignable. Thus, when the adjustment partner X selects time frame 1 as the assembly time/date, for example, the assembly plan is assigned to the team (ABC).

When “assign automatically (assign one person)” is selected as the assignment participant in the assignment method, “at random” is selected as the assignment order, and the adjustment partner X selects time frame 1 as the assembly time/date, for example, the assembly plan of time frame 1 is assigned at random to one of the assignable teams (A), (B), and (C). For example, when the adjustment partner X selects time frame 2 as the assembly time/date, the assembly plan of time frame 2 is assigned at random to one of the assignable teams (A) and (B).

When “assign automatically (assign one person)” is selected as the assignment participant in the assignment method, “order of priority” is selected as the assignment order, the teams (C), (B), and (A) are set in this order in descending order of the order of priority, and the adjustment partner X selects time frame 1 as the assembly time/date, for example, the assembly plan of time frame 1 is assigned to the team (C) having the highest order of priority out of the assignable teams (A), (B), and (C). For example, when the adjustment partner X selects time frame 2 as the assembly time/date, the assembly plan of time frame 2 is assigned to the team (B) having the higher order of priority out of the assignable teams (A) and (B).

When “assign automatically (with use of advanced assignment calculation expression)” is selected as the assignment participant in the assignment method, the assignment calculation expression “(A and B) or C” is set, “at random” is selected as the assignment order, and the adjustment partner X selects time frame 1 as the assembly time/date, for example, the assembly plan of time frame 1 is assigned at random to one of the assignable teams (AB) and (C). For example, when the adjustment partner X selects time frame 2 as the assembly time/date, only the team (AB) is assignable, and thus the assembly plan of time frame 2 is assigned to the team (AB).

When “assign automatically (with use of advanced assignment calculation expression)” is selected as the assignment participant in the assignment method, the assignment calculation expression “(A and B) or C” is set, “order of priority” is selected as the assignment order, the teams (C) and (AB) are set in this order in descending order of the order of priority as the assignment order, and the adjustment partner X selects time frame 1 as the assembly time/date, for example, the assembly plan of time frame 1 is assigned to the team (C) having the higher order of priority out of the assignable teams (AB) and (C). For example, when the adjustment partner X selects time frame 2 as the assembly time/date, only the team (AB) is assignable, and thus the assembly plan of time frame 2 is assigned to the team (AB).

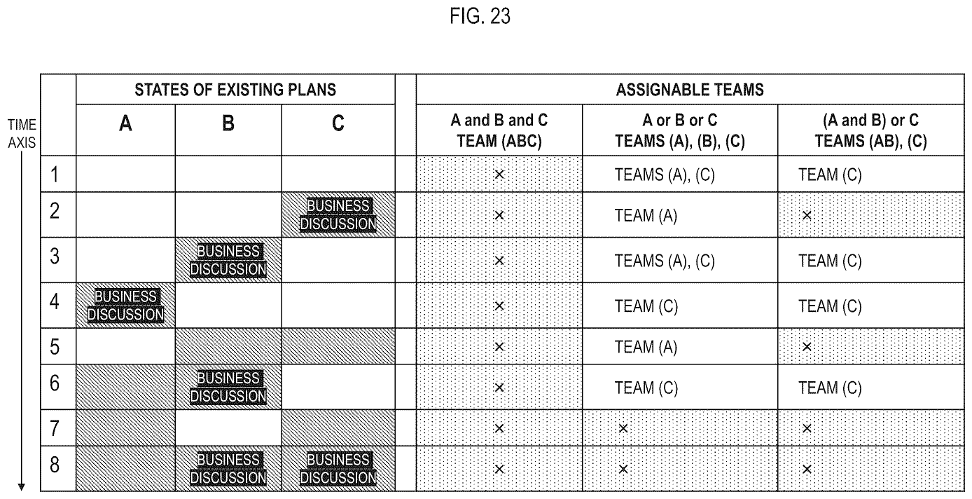

Next, FIG. 23 is a diagram for illustrating an example of teams that can be assigned the assembly and the assignment method corresponding to a case in which the assignment order is at random or the order of priority, the assignment upper limit number is provided, the determination unit span is “day unit”, the assignment upper limit number is 3 being “equal for all” or “equal for teams”, and the determination target plan is “perform upper limit determination using number of existing plans with keyword “business discussion” being included in topic”. Note that the team division, the states of the existing plans of the participant candidates A, B, and C, and the setting related to the assignment upper limit number (the determination unit span, the assignment upper limit number, and the determination target plan) are similar to those of FIG. 18, and thus the second candidate time/dates presented to the adjustment partner X are also similar to those of FIG. 18. Thus, the time frames described with “x” are not included in the second candidate time/dates presented to the adjustment partner X, and are not selected by the adjustment partner X as the assembly time/dates. FIG. 23 is a state in which there are one existing plan “business discussion” for the participant candidate A, three existing plans “business discussion” for the participant candidate B, and two existing plans “business discussion” for the participant candidate C on the day, similarly to FIG. 18.

In the case of FIG. 23, there are already three existing plans “business discussion” for the participant candidate B on the day, and thus the number reaches 3 being the assignment upper limit number of the day unit. Thus, the assembly plan is not assigned to the teams (A, B, C), (B), and (AB) to which the participant candidate B belongs.

When “assign all” is selected as the assignment participant in the assignment method, the team of the participant candidates is only one team of the team (ABC). Note that, as illustrated in FIG. 18, for the team (ABC), the number of existing plans “business discussion” of the belonging participant candidate B reaches 3 being the assignment upper limit number, and accordingly, in Step S162, time frames 1 to 8 on the day are not the first candidate time/dates for the team (ABC) or the second candidate time/dates, and thus none of time frames 1 to 8 on the day is selected by the adjustment partner X as the assembly time/date.

When “assign automatically (assign one person)” is selected as the assignment participant in the assignment method and “at random” is selected as the assignment order, as described above, the team (B) is unassignable, and thus when the adjustment partner X selects time frame 1 as the assembly time/date, for example, the assembly plan of time frame 1 is assigned at random to one of the assignable teams (A) and (C). For example, when the adjustment partner X selects time frame 2 as the assembly time/date, the assignable team is only the team (A), and thus the assembly plan of time frame 2 is assigned to the team (A).

When “assign automatically (assign one person)” is selected as the assignment participant in the assignment method, “order of priority” is selected as the assignment order, and the teams (C), (B), and (A) are set in this order in descending order of the order of priority, as described above, the team (B) is unassignable, and thus when the adjustment partner X selects time frame 1 as the assembly time/date, for example, the assembly plan of time frame 1 is assigned to the team (C) having the higher order of priority out of the assignable teams (A) and (C). For example, when the adjustment partner X selects time frame 2 as the assembly time/date, the assignable team is only the team (A), and thus the assembly plan of time frame 2 is assigned to the team (A).

When “assign automatically (with use of advanced assignment calculation expression)” is selected as the assignment participant in the assignment method, the assignment calculation expression “(A and B) or C” is set, and “at random” is selected as the assignment order, as described above, the team (AB) is unassignable and the assignable team is only the team (C), and thus when the adjustment partner X selects time frame 1 as the assembly time/date, for example, the assembly plan of time frame 1 is assigned to the team (C). For example, when the adjustment partner X selects time frame 3 as the assembly time/date, the assignable team is only the team (C), and thus the assembly plan of time frame 3 is assigned to the team (C).

When “assign automatically (with use of advanced assignment calculation expression)” is selected as the assignment participant in the assignment method, the assignment calculation expression “(A and B) or C” is set, “order of priority” is selected as the assignment order, and the teams (C) and (AB) are set in this order in descending order of the order of priority as the assignment order, as described above, the team (AB) is unassignable and the assignable team is only the team (C), and thus when the adjustment partner X selects time frame 1 as the assembly time/date, for example, the assembly plan of time frame 1 is assigned to the team (C). For example, when the adjustment partner X selects time frame 3 as the assembly time/date, the assignable team is only the team (C), and thus the assembly plan of time frame 3 is assigned to the team (C).

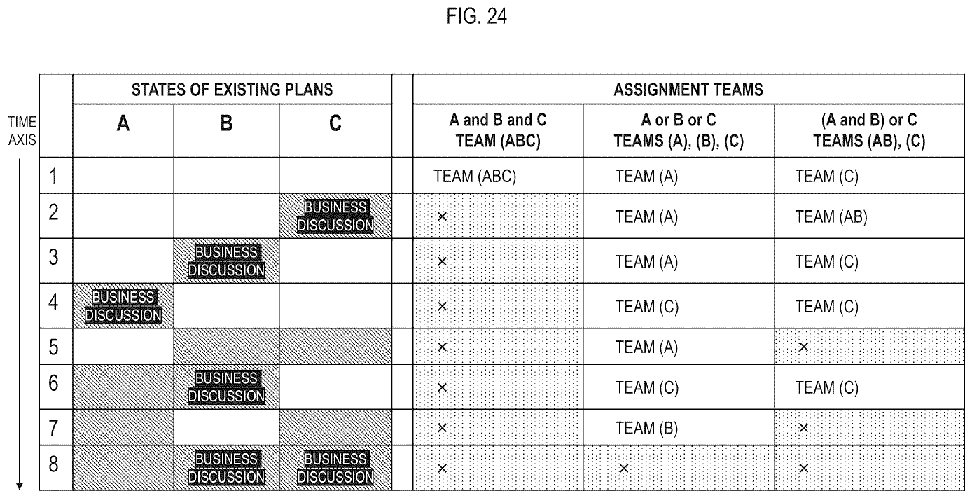

Next, FIG. 24 is a diagram for illustrating an example of teams to be assigned the assembly and the assignment method corresponding to a case in which the assignment order is equal assignment, the assignment upper limit number is not provided, the determination unit span is “day unit”, and the determination target plan is “equalize number of existing plans with keyword “business discussion” being included in topic”. Note that the team division, the states of the existing plans of the participant candidates A, B, and C, and the setting related to the assignment upper limit number are similar to those of FIG. 17, and thus the second candidate time/dates presented to the adjustment partner X are also similar to those of FIG. 17. Thus, the time frames described with “x” are not included in the second candidate time/dates presented to the adjustment partner X, and are not selected by the adjustment partner X as the assembly time/dates. FIG. 24 is a state in which there are one existing plan “business discussion” for the participant candidate A, three existing plans “business discussion” for the participant candidate B, and two existing plans “business discussion” for the participant candidate C on the day which are used for determination of equal assignment, in addition to FIG. 17.

When “assign all” is selected as the assignment participant in the assignment method, the team of the participant candidates is only the team (ABC), and only the team (ABC) is assignable. Thus, when the adjustment partner X selects time frame 1 as the assembly time/date, for example, the assembly plan of time frame 1 is assigned to the team (ABC).

When “assign automatically (assign one person)” is selected as the assignment participant in the assignment method and the adjustment partner X selects time frame 1 as the assembly time/date, for example, the assembly plan of time frame 1 is assigned to the team (A) out of the teams (A), (B), and (C) having no existing plans in time frame 1. In other words, the number of existing plans “business discussion” on the day is 1 for the team (A), 3 for the team (B), and 2 for the team (C), and thus in order to equalize the numbers of existing plans “business discussion”, the assembly plan of time frame 1 is assigned to the team (A) having the smallest number of existing plans “business discussion”. For example, when the adjustment partner X selects time frame 4 as the assembly time/date, the assembly plan of time frame 4 is assigned to the team (C) out of the teams (B) and (C) having no existing plans in time frame 4. In other words, the number of existing plans “business discussion” on the day is 3 for the team (B) and 2 for the team (C), and thus in order to equalize the numbers of existing plans “business discussion”, the assembly plan of time frame 4 is assigned to the team (C) having the smallest number of existing plans “business discussion”.

When “assign automatically (with use of advanced assignment calculation expression)” is selected as the assignment participant in the assignment method, the assignment calculation expression “(A and B) or C” is set, and the adjustment partner X selects time frame 1 as the assembly time/date, for example, the assembly plan of time frame 1 is assigned to the team (C) out of the teams (AB) and (C) having no existing plans in time frame 1. In other words, on the day, the number of existing plans “business discussion” is 3 for the team (AB) (the larger value of the numbers of existing plans “business discussion” of the belonging participant candidates A and B) and 2 for the team (C), and thus in order to equalize the numbers of existing plans “business discussion”, the assembly plan of time frame 1 is assigned to the team (C) having the smallest number of existing plans “business discussion”. For example, when the adjustment partner X selects time frame 2 as the assembly time/date, the team having no existing plans in time frame 2 is only the team (AB), and thus the assembly plan of time frame 2 is assigned to the team (AB).

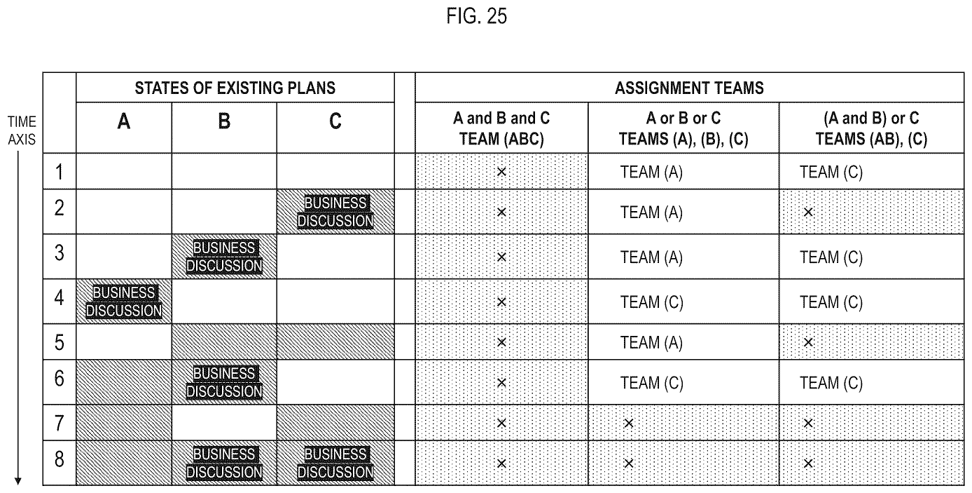

Next, FIG. 25 is a diagram for illustrating an example of teams to be assigned the assembly and the assignment method corresponding to a case in which the assignment order is equal assignment, the assignment upper limit number is provided, the determination unit span is “day unit”, the assignment upper limit number is 3 being “equal for all” or “equal for teams”, and the determination target plan is “equalize number of existing plans with keyword “business discussion” being included in topic”. Note that the team division, the states of the existing plans of the participant candidates A, B, and C, and the setting related to the assignment upper limit number (the determination unit span, the assignment upper limit number, and the determination target plan) are similar to those of FIG. 18, and thus the second candidate time/dates presented to the adjustment partner X are also similar to those of FIG. 18. Thus, the time frames described with “x” are not included in the second candidate time/dates presented to the adjustment partner X, and are not selected by the adjustment partner X as the assembly time/dates. FIG. 25 is a state in which there are one existing plan “business discussion” for the participant candidate A, three existing plans “business discussion” for the participant candidate B, and two existing plans “business discussion” for the participant candidate C on the day, similarly to FIG. 18.

In the case of FIG. 25, for the participant candidate B, the number of existing plans “business discussion” reaches 3 being the assignment upper limit number. Thus, the assembly plan is not assigned to the teams (A, B, C), (B), and (AB) to which the participant candidate B belongs.

When “assign all” is selected as the assignment participant in the assignment method, the team of the participant candidates is only one team of one team (ABC). Note that, as illustrated in FIG. 18, for the team (ABC), the number of existing plans “business discussion” of the belonging participant candidate B reaches 3 being the assignment upper limit number, and accordingly, in Step S162, time frames 1 to 8 on the day are not the first candidate time/dates for the team (ABC) or the second candidate time/dates, and thus none of time frames 1 to 8 on the day is selected by the adjustment partner X as the assembly time/date.

When “assign automatically (assign one person)” is selected as the assignment participant in the assignment method, as described above, the team (B) is unassignable, and thus when the adjustment partner X selects time frame 1 as the assembly time/date, for example, the assembly plan of time frame 1 is assigned to the team (A) out of the assignable teams (A) and (C). In other words, on the day, the number of existing plans “business discussion” is 1 for the team (A) and 2 for the team (C), and thus in order to equalize the numbers of existing plans “business discussion”, the assembly plan of time frame 1 is assigned to the team (A) having the smallest number of existing plans “business discussion”. For example, when the adjustment partner X selects time frame 2 as the assembly time/date, the assignable team is only the team (A), and thus the assembly plan of time frame 2 is assigned to the team (A).

When “assign automatically (with use of advanced assignment calculation expression)” is selected as the assignment participant in the assignment method and the assignment calculation expression “(A and B) or C” is set, as described above, the team (AB) is unassignable, and thus when the adjustment partner X selects time frame 1 as the assembly time/date, for example, the assembly plan of time frame 1 is assigned to the assignable team (C). The same holds true for a case in which time frames 3, 4, and 6 are selected.

Note that, although not illustrated in FIG. 24 and FIG. 25, in the time frame selected by the adjustment partner X as the assembly time/date, there may be a plurality of teams having the smallest numbers of existing plans “business discussion”. In that case, regardless of to which team the assembly plan is assigned out of the plurality of teams, the state of equalization is not changed, and thus the assembly plan may be assigned at random to any of the teams of the plurality of teams. Alternatively, the assembly plan may be assigned according to a certain rule, such as the order of arrangement of the participant candidates in the selection input field 1401.

FIG. 14 is referred to again. Next, the time/date adjustment unit 213 registers the plan of the assembly in the schedule information 311 of the participant candidates belonging to the team assigned the assembly plan managed by the calendar tool 31 (Step S167). Note that, in that case, the time/date adjustment unit 213 acquires the plan ID for identifying the plan registered in the calendar tool 31 from the calendar tool 31, and additionally registers the plan ID in the time/date adjustment information 224 registered in Step S166.

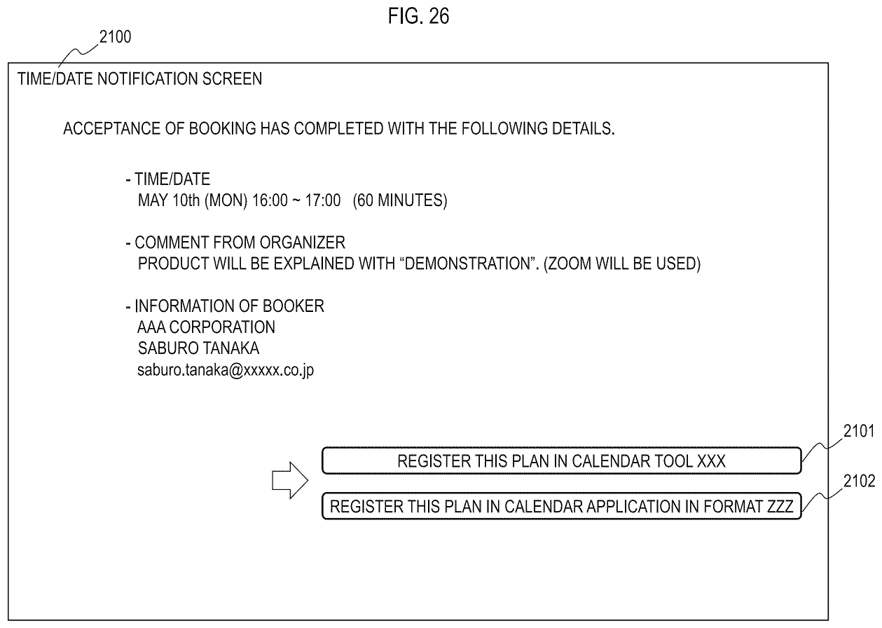

Next, the time/date adjustment unit 213 causes the terminal apparatus 40X to display a time/date notification screen 2100 (FIG. 26) (Step S168).

FIG. 26 illustrates a display example of the time/date notification screen 2100. On the time/date notification screen 2100, the confirmed time/date of the assembly, the comment from the organizer, and the like are displayed. The time/date notification screen 2100 is provided with a registration button 2101 for indicating registration of the plan with a specific type of calendar tool and a registration button 2102 for indicating registration of the plan with a calendar tool using a certain prescribed data format. The adjustment partner X performs operation on the registration button 2101 or the registration button 2102 depending on a type of calendar tool used by the adjustment partner X, and can thereby register the plan of the confirmed assembly with the calendar tool used by the adjustment partner X themselves as the plan of the adjustment partner X themselves.

Note that, in the present embodiment, after determining the team to be assigned the assembly plan, in Step S166, the information of the confirmed assembly is registered in the time/date adjustment information 224, and next, in Step S167, the plan of the assembly is registered in the schedule information 311 of the participant candidates belonging to the team assigned the assembly plan; however, the order of registration of the information in the time/date adjustment information 224 and registration of the plan in the schedule information 311 may be interchanged.

Next, the time/date adjustment unit 213 transmits the notification email for notifying the adjustment partner X of details of the assembly to the email address designated by the adjustment partner X, in accordance with the timing of notification selected by the adjustment partner X themselves (Step S169).

Note that, in the present embodiment, an arrow from the time/date adjustment apparatus 20 to the terminal apparatus 40X is illustrated as Step S169, on the assumption that the adjustment partner X receives the electronic mail using the terminal apparatus 40X; however, the adjustment partner X may receive the notification email from the time/date adjustment apparatus 20, using an electronic device other than the terminal apparatus 40X.

Next, the time/date adjustment unit 213 transmits, to the adjustment initiator A who has created the adjustment condition template, the notification email for notifying the adjustment initiator A of details of the assembly (Step S170). Note that the notification email may be transmitted not only to the adjustment initiator A but also to the participant candidates assigned the assembly plans. Alternatively, the notification email may be transmitted only to the participant candidates assigned the assembly plans.

According to the time/date adjustment processing described above, as the operation of the adjustment initiator A, by merely selecting the adjustment condition template and transmitting the booking acceptance URL to the adjustment partner X after creating the adjustment condition template, a booking for a new business discussion or the like can be automatically accepted, and therefore time and efforts of the adjustment initiator A can be significantly reduced.

According to the time/date adjustment apparatus, time/date adjustment can be automatically performed in consideration of the available time/dates of each participant candidate on the schedule, and thus occurrence of a double booking (overlapping of plans) in the schedule of each participant candidate can be prevented.

Moreover, according to the time/date adjustment processing, a plurality of participant candidates can be subjected to team division according to the assignment calculation expression, and thus the plan can be assigned to a team that can participate on the time/date confirmed by the adjustment partner X, at random, in order of priority, or equally in a unit span.

Moreover, control can be performed so that a certain number or more of assembly plans are not made in the unit span for the participant candidates and the team of the participant candidates, using the states of the existing plans in the unit span as a criterion.

In addition, because the adjustment condition template can be repeatedly used and the booking acceptance URL corresponding to each adjustment condition template is fixed, for example, by attaching a link to a website of a company or attaching a link of the booking acceptance URL subsequently to an input of an inquiry form for guidance, time/date adjustment can be performed without the time and efforts taken to transmit the booking acceptance URL to the adjustment partner X.

By attaching the booking acceptance URL to an email for simultaneous distribution or the like, the booking acceptance URL can be simultaneously transmitted to a plurality of adjustment partners X.

Typically, for example, the time/date adjustment apparatus of the present embodiment can prepare various operation screens as web pages, and can display such operation screens in a web browser of the terminal apparatus. However, this aspect is not restrictive. For example, a dedicated application including various operation screens may be installed in the terminal apparatus. In this case, by transmitting a part of contents (data such as candidate time/dates) to be displayed on various operation screens to the terminal apparatus, the time/date adjustment apparatus can cause the dedicated application of the terminal apparatus to display various operation screens. In other words, the time/date adjustment apparatus of the present invention may also encompass various aspects in which screens can be displayed in the terminal apparatus.

The present invention is not limited to the embodiments and modifications described above, and further various modifications can be made. For example, the embodiments and the modifications described above are described in detail in order to give simple description of the present invention, and are not necessarily limited to those including all of the configurations described above. A part of one modification may be replaced with another modification, or modifications may be combined together.

A part or all of each configuration, function, processing unit, processing means, and the like described above may be, for example, implemented with hardware by designing those with an integrated circuit, for example. Each configuration, function, and the like described above may be implemented with software by a processor interpreting and executing a program for implementing their respective functions. Information such as a program, a table, and a file for implementing respective functions may be stored in a recording apparatus such as a memory, a hard disk, and an SSD, or a recording medium such as an IC card, an SD card, and a DVD. Illustrated control lines and information lines are those considered to be necessary for the sake of description, and not necessarily all of control lines and information lines for a product are illustrated. It may be considered that most of the configurations are connected to each other in actuality.

### Reference Signs List

10 . . . Time/date adjustment system
11 . . . Network
20 . . . Time/date adjustment apparatus
21 . . . Processing unit
211 . . . Authentication unit
212 . . . Adjustment condition setting unit
213 . . . Time/date adjustment unit
22 . . . Storage unit
221 . . . Member information
222 . . . User information
223 . . . Adjustment condition template information
224 . . . Time/date adjustment information
23 . . . Communication unit
30 . . . Task management system
31 . . . Calendar tool
311 . . . Schedule information
40A, 40M, 40X . . . Terminal apparatus
1000 . . . Adjustment condition template list screen
1200 . . . Template management information input screen
1300 . . . Date and time information input screen
1400 . . . Participant information input screen
1500 . . . Calculation expression editing screen
1600 . . . Comment confirmation screen
1800 . . . Time/date selection screen
1900 . . . Time/date confirmation screen
2000 . . . Booker information input screen
2100 . . . Time/date notification screen

1. A time/date adjustment apparatus comprising:
an adjustment condition setting unit configured to set an adjustment condition template that can be repeatedly used for time/date adjustment of different assemblies; and
a time/date adjustment unit configured to perform adjustment of an assembly time/date, based on the adjustment condition template, wherein
the adjustment condition setting unit registers participant candidates in the assembly and an adjustment condition including an assignment method including an assignment calculation expression and an assignment order in the adjustment condition template, based on input from an adjustment initiator, and
the time/date adjustment unit,
in response to an adjustment partner performing access based on access information corresponding to the adjustment condition template,
segments the participant candidates into teams, based on the assignment calculation expression,
refers to schedule information of the participant candidates managed by a calendar tool,
extracts common available time/dates satisfying the adjustment condition of all of the participant candidates constituting the team as first candidate time/dates for each of the teams,
determines time/dates being the first candidate time/dates of at least one of the teams as second candidate time/dates,
presents the second candidate time/dates to a terminal apparatus used by the adjustment partner,
in response to selection of the adjustment partner, determines the assembly time/date out of the presented second candidate time/dates, and
assigns a plan of the assembly time/date to one of the teams in which the determined assembly time/date is extracted as the first candidate time/dates according to the assignment order.

2. The time/date adjustment apparatus according to claim 1, wherein
based on input from the adjustment initiator, the adjustment condition setting unit registers the adjustment condition including a determination unit span and an assignment upper limit number in the adjustment condition template, and
the time/date adjustment unit excludes all of the time/dates in the determination unit span in which the number of determination target plans of the participant candidate in the determination unit span is equal to or more than the assignment upper limit number from the first candidate time/dates of the team to which the participant candidate in which the number of determination target plans in the determination unit span is equal to or more than the assignment upper limit number belongs.

3. The time/date adjustment apparatus according to claim 1, wherein
based on input from the adjustment initiator, the adjustment condition setting unit registers the adjustment condition including a determination unit span in the adjustment condition template, and
the time/date adjustment unit
counts the number of determination target plans of each of the participant candidates in the determination unit span including the determined assembly time/date,
regards a maximum value of the number of determination target plans of each of the participant candidates belonging to the team as the number of determination target plans of the team to which the participant candidates belong, and
assigns the plan of the assembly time/date to the team having a smallest number of determination target plans in the determination unit span including the determined assembly time/date out of the teams in which the determined assembly time/date is extracted as the first candidate time/dates.

4. The time/date adjustment apparatus according to claim 2, wherein
the adjustment condition setting unit considers the plan of the assembly time/date determined using the same adjustment condition template as the determination target plan.

5. The time/date adjustment apparatus according to claim 2, wherein
the adjustment condition setting unit,
in response to input by the adjustment initiator, registers the adjustment condition including designation of a determination keyword in the adjustment condition template, and
considers an existing plan in which information related to the existing plan includes the determination keyword out of the existing plans of the participant candidate in the schedule information as the determination target plan.

6. The time/date adjustment apparatus according to claim 2, wherein
the adjustment condition setting unit causes the adjustment initiator to select a day unit, a week unit, or a month unit as the determination unit span.

7. The time/date adjustment apparatus according to claim 2, wherein
the adjustment condition setting unit causes the adjustment initiator to select one of the assignment upper limit number being equal for the teams, the assignment upper limit number for each of the teams, the assignment upper limit number being equal for the participant candidates, or the assignment upper limit number for each of the participant candidates, as the assignment upper limit number.

8. The time/date adjustment apparatus according to claim 1, wherein
based on the assignment calculation expression, the time/date adjustment unit divides the participant candidates into the teams, each team including one or two or more of the participant candidates.

9. The time/date adjustment apparatus according to claim 1, wherein
the time/date adjustment unit registers the plan of the assembly time/date in the schedule information of the participant candidates constituting the team assigned the plan of the assembly time/date.

10. The time/date adjustment apparatus according to claim 1, wherein
the time/date adjustment unit notifies the participant candidates constituting the team assigned the plan of the assembly time/date of the plan of the assembly time/date.

11. A time/date adjustment method performed by a time/date adjustment apparatus, the time/date adjustment method comprising:
an adjustment condition setting step of setting an adjustment condition template that can be repeatedly used for time/date adjustment of different assemblies; and
a time/date adjustment step of performing adjustment of an assembly time/date, based on the adjustment condition template, wherein
the adjustment condition setting step includes registering participant candidates in the assembly and an adjustment condition including an assignment method including an assignment calculation expression and an assignment order in the adjustment condition template, based on input from an adjustment initiator, and
the time/date adjustment step includes,
in response to an adjustment partner performing access based on access information corresponding to the adjustment condition template,
segmenting the participant candidates into teams, based on the assignment calculation expression,
referring to schedule information of the participant candidates managed by a calendar tool,
extracting common available time/dates satisfying the adjustment condition of all of the participant candidates constituting the team as first candidate time/dates for each of the teams,
determining time/dates being the first candidate time/dates of at least one of the teams as second candidate time/dates,
presenting the second candidate time/dates to a terminal apparatus used by the adjustment partner,
in response to selection of the adjustment partner, determining the assembly time/date out of the presented second candidate time/dates, and
assigning a plan of the assembly time/date to one of the teams in which the determined assembly time/date is extracted as the first candidate time/dates according to the assignment order.

12. A non-transitory computer-readable storage medium storing a program causing a computer to function as:
an adjustment condition setting unit configured to set an adjustment condition template that can be repeatedly used for time/date adjustment of different assemblies; and
a time/date adjustment unit configured to perform adjustment of an assembly time/date, based on the adjustment condition template, wherein
the adjustment condition setting unit registers participant candidates in the assembly and an adjustment condition including an assignment method including an assignment calculation expression and an assignment order in the adjustment condition template, based on input from an adjustment initiator, and
the time/date adjustment unit,
in response to an adjustment partner performing access based on access information corresponding to the adjustment condition template,
segments the participant candidates into teams, based on the assignment calculation expression,
refers to schedule information of the participant candidates managed by a calendar tool,
extracts common available time/dates satisfying the adjustment condition of all of the participant candidates constituting the team as first candidate time/dates for each of the teams,
determines time/dates being the first candidate time/dates of at least one of the teams as second candidate time/dates,
presents the second candidate time/dates to a terminal apparatus used by the adjustment partner,
in response to selection of the adjustment partner, determines the assembly time/date out of the presented second candidate time/dates, and
assigns a plan of the assembly time/date to one of the teams in which the determined assembly time/date is extracted as the first candidate time/dates according to the assignment order.

13. The time/date adjustment apparatus according to claim 3, wherein
the adjustment condition setting unit considers the plan of the assembly time/date determined using the same adjustment condition template as the determination target plan.

14. The time/date adjustment apparatus according to claim 3, wherein
the adjustment condition setting unit,
in response to input by the adjustment initiator, registers the adjustment condition including designation of a determination keyword in the adjustment condition template, and
considers an existing plan in which information related to the existing plan includes the determination keyword out of the existing plans of the participant candidate in the schedule information as the determination target plan.

15. The time/date adjustment apparatus according to claim 3, wherein
the adjustment condition setting unit causes the adjustment initiator to select a day unit, a week unit, or a month unit as the determination unit span.
